(19) United States
(12) Patent Application Publication
(10) Pub. No.: US 2015/0083605 A1
(43) Pub. Date: Mar. 26, 2015

(54) SEMICONDUCTOR PHOTOELECTRODE AND METHOD FOR SPLITTING WATER PHOTOELECTROCHEMICALLY USING PHOTOELECTROCHEMICAL CELL COMPRISING THE SAME

(71) Applicant: Panasonic Corporation, Osaka (JP)

(72) Inventors: SATORU TAMURA, Osaka (JP); KAZUHITO HATO, Osaka (JP); KENICHI TOKUHIRO, Osaka (JP); TAKAHIRO KURABUCHI, Osaka (JP); MINORU MIZUHATA, Hyogo (JP)

(21) Appl. No.: 14/558,673

(22) Filed: Dec. 2, 2014

Related U.S. Application Data
(63) Continuation of application No. PCT/JP2014/002228, filed on Apr. 21, 2014.

(30) Foreign Application Priority Data
Apr. 26, 2013 (JP) 2013-093528

(51) Int. Cl. C25B 1/00; B01J 21/06; B01J 27/24; C25B 11/04; C25B 1/04

(52) U.S. Cl. CPC C25B 1/003; C25B 11/0405; C25B 11/0478; C25B 1/04; B01J 27/24; B01J 21/063
USPC 205/340; 204/289; 204/242

(57) ABSTRACT

Provided is a semiconductor photoelectrode comprising a conductive substrate; a first semiconductor photocatalyst layer provided on a surface of the conductive substrate; a second semiconductor photocatalyst layer provided on a surface of the first semiconductor photocatalyst layer. The semiconductor photoelectrode has a plurality of pillar protrusions on the surface thereof. A surface of each of the pillar protrusions is formed of the second semiconductor photocatalyst layer.

This is a continuation of International Application No. PCT/JP2014/002228, with an international filing date of Apr. 21, 2014, which claims priority of Japanese Patent Application No. 2013-093528, filed on Apr. 26, 2013, the contents of which are hereby incorporated by reference.

### BACKGROUND

1. Field of the Invention

The present invention relates to a semiconductor photoelectrode and a method for splitting water photoelectrochemically using a photoelectrochemical cell comprising the same.

2. Description of the Related Art

In order to solve increasingly serious environmental problems and energy problems for a sustainable society, it is required to put renewable energy into practical use on a full scale. Recently, a system for storing an electric power generated by a solar cell in a secondary battery has been widely used. However, it is not easy to move a secondary battery due to its weight. For this reason, hydrogen is expected to be used as an energy medium in the future. The advantage of hydrogen as an energy medium is now described below. First, hydrogen is easy to be stored. It is also easy to transfer a tank containing hydrogen. Next, a final product generated after hydrogen is combusted is water, which is harmless, safe, and clean. Furthermore, hydrogen is supplied to a fuel cell to convert it into electric power and heat. Lastly, hydrogen is formed inexhaustible in water splitting.

For this reason, a technology for generating hydrogen by splitting water photoelectrochemically using photocatalyst and sunlight has attractiveness, since sunlight is converted easily into an easy-to-use energy medium using the technology. Research and development has been promoted to improve generation efficiency of hydrogen.

WO2011/058723 discloses a photoelectrochemical cell relative to the technology. In particular, as shown in FIG. 1, the photoelectrochemical cell 100 disclosed in WO2011/058723 comprises a semiconductor electrode 120 which includes a conductor 121, a first n-type semiconductor layer 122 having a nanotube array structure, and a second n-type semiconductor layer 123; a counter electrode 130 connected to the conductor 121; an electrolyte solution 140 in contact with the second n-type semiconductor layer 123 and the counter electrode 130; and a container 110 which contains the semiconductor electrode 120, the counter electrode 130, and the electrolyte solution 140. On the basis of a vacuum level, (I) the band edge levels of the conduction band and the valence band in the second n-type semiconductor layer 123 are higher than the band edge levels of the conduction band and the valence band in the first n-type semiconductor layer 122, respectively, and (II) the Fermi level of the first n-type semiconductor layer 122 is higher than that of the second n-type semiconductor layer 123, and (III) the Fermi level of the conductor 121 is higher than that of the first n-type semiconductor layer 122.

### SUMMARY

In order to improve the generation efficiency of hydrogen, it is necessary to improve quantum efficiency of the semiconductor electrode furthermore.

An object of the present invention is to provide a semiconductor photoelectrode having high quantum efficiency and a method for splitting water photoelectrochemically using a photoelectrochemical cell comprising the same to improve the hydrogen generation efficiency.

The present invention provides a semiconductor photoelectrode, comprising:

a conductive substrate;
a first semiconductor photocatalyst layer provided on a surface of the conductive substrate;

a second semiconductor photocatalyst layer provided on a surface of the first semiconductor photocatalyst layer,
wherein
an energy difference between Fermi level of the conductive substrate and vacuum level is smaller than an energy difference between Fermi level of the first semiconductor photocatalyst layer and the vacuum level;

an energy difference between Fermi level of the first semiconductor photocatalyst layer and the vacuum level is smaller than an energy difference between Fermi level of the second semiconductor photocatalyst layer and the vacuum level;

an energy difference between a top of a valence band of the first semiconductor photocatalyst layer and the vacuum level is greater than an energy difference between a top of a valence band of the second semiconductor photocatalyst layer and the vacuum level;

an energy difference between a bottom of a conduction band of the first semiconductor photocatalyst layer and the vacuum level is greater than an energy difference between a bottom of a conduction band of the second semiconductor photocatalyst layer and the vacuum level;

the semiconductor photoelectrode has a plurality of pillar protrusions on the surface thereof; and
a surface of each of the pillar protrusions is formed of the second semiconductor photocatalyst layer.

The present invention provides a semiconductor photoelectrode having high quantum efficiency and a method for splitting water photoelectrochemically using a photoelectrochemical cell comprising the same to improve the generation efficiency of hydrogen.

### BRIEF DESCRIPTION OF THE DRAWINGS

FIG. 1 shows the photoelectrochemical cell disclosed in WO2011/058723.

FIG. 2 shows a measurement result of a steady state polarization curve of water splitting using two flat-and-smooth platinum electrodes included in a dilute sulfuric acid aqueous solution.

FIG. 3 shows a band structure of a semiconductor photocatalyst used for a semiconductor photoelectrode.

FIG. 4A shows a band structure before a conductive substrate 102 and a first semiconductor photocatalyst layer 202 form the junction in a case where the first semiconductor photocatalyst layer 202 is formed of n-type semiconductor.

FIG. 4B shows a band structure after the conductive substrate 102 and the first semiconductor photocatalyst layer 202 have formed the junction in a case where the first semiconductor photocatalyst layer 202 is formed of n-type semiconductor.

FIG. 5A shows a band structure before the conductive substrate 102 and the first semiconductor photocatalyst layer 202 form the junction in a case where the first semiconductor photocatalyst layer 202 is formed of p-type semiconductor.

FIG. 5B shows a band structure after the conductive substrate 102 and the first semiconductor photocatalyst layer 202 have formed the junction in a case where the first semiconductor photocatalyst layer 202 is formed of p-type semiconductor.

FIG. 6 shows a semiconductor photoelectrode 200 according to the first embodiment.

FIG. 7A shows a band structure before the conductive substrate 102, the first semiconductor photocatalyst layer 202, and a second semiconductor photocatalyst layer 203 form the junction in a case where both the first semiconductor photocatalyst layer 202 and the second semiconductor photocatalyst layer 203 are formed of n-type semiconductor.

FIG. 7B shows a band structure after the conductive substrate 102, the first semiconductor photocatalyst layer 202, and the second semiconductor photocatalyst layer 203 have formed the junction in a case where both the first semiconductor photocatalyst layer 202 and the second semiconductor photocatalyst layer 203 are formed of n-type semiconductor.

FIG. 8A shows a band structure before the conductive substrate 102, the first semiconductor photocatalyst layer 202, and the second semiconductor photocatalyst layer 203 form the junction in a case where both the first semiconductor photocatalyst layer 202 and the second semiconductor photocatalyst layer 203 are formed of p-type semiconductor.

FIG. 8B shows a band structure after the conductive substrate 102, the first semiconductor photocatalyst layer 202, and the second semiconductor photocatalyst layer 203 have formed the junction in a case where both the first semiconductor photocatalyst layer 202 and the second semiconductor photocatalyst layer 203 are formed of p-type semiconductor.

FIG. 9 shows a photoelectrochemical cell according to the second embodiment.

FIG. 10 shows how to use the photoelectrochemical cell according to the second embodiment.

FIG. 11 is a graph showing the results of the calculated external quantum efficiency and internal quantum efficiency in the reference example 1.

FIG. 12A shows a SEM image (5,000 magnifications) of the surface of the replica film patterned in the reference example 2.

FIG. 12B shows a SEM image (50,000 magnifications) of the surface of the replica film patterned in the reference example 2.

FIG. 13 shows a relation between a thickness of a thin film made of TiO₂ and the film-forming time in the reference example 2.

FIG. 14 shows a SEM image of the surface of the obtained electrode in the reference example 2.

FIG. 15 shows the results of the photocurrent measurement in the reference example 2.

FIG. 16 shows the results of the photocurrent measurement in the reference example 3.

FIG. 17 shows an example of a plurality of pillar protrusions formed on the surface of the semiconductor photoelectrode.

FIG. 18 shows desirable pillar protrusions.

FIG. 19 shows pillar protrusions each having light scattering particles.

FIG. 20 is a graph showing the transmittance T, the reflectance R, and the absorptance of the TiO₂ film in the reference example 1.

FIG. 21 shows a top view of this Si pillar protrusion substrate used in the example 1.

FIG. 22 shows a cross-sectional photograph of the Si pillar protrusion substrate used in the example 1.

FIG. 23 shows a graph showing the results of the photocurrent measurement in the example 1.

FIG. 24 shows a graph showing the results of the photocurrent measurement in the example 1 and the comparative example 1.

### DETAILED DESCRIPTION OF THE EMBODIMENTS

The embodiments of the present invention will be described below with reference to the drawings. The following embodiments are merely preferable instances of the present invention. The present invention is not limited to the following embodiments. In the following description, the same components are designated by the same reference numerals, and hence repetitive description is omitted.

### First Embodiment

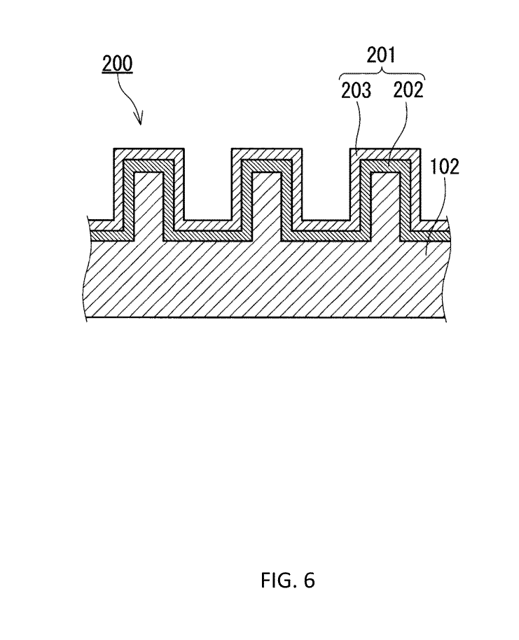

FIG. 6 shows a semiconductor photoelectrode 200 according to the first embodiment. The semiconductor photoelectrode 200 comprises a first semiconductor photocatalyst layer 202 disposed on the surface of a conductive substrate 102 and a second semiconductor photocatalyst layer 203 disposed on the surface of the first semiconductor photocatalyst layer 202. The first semiconductor photocatalyst layer 202 has a surface shape similar to pillar protrusions formed on the surface of the conductive substrate 102. The second semiconductor photocatalyst layer 203 also has a surface shape similar to pillar protrusions formed on the surface of the first semiconductor photocatalyst layer 202. The first semiconductor photocatalyst layer 202 is sandwiched between the conductive substrate 102 and the second semiconductor photocatalyst layer 203. The front surface of the first semiconductor catalyst layer 202 is in contact with the back surface of the second semiconductor photocatalyst layer 203. The back surface of the first semiconductor photocatalyst layer 202 is in contact with the front surface of the conductive substrate 102. In this manner, a semiconductor photocatalyst layer 201 is composed of a stacked structure of the first semiconductor photocatalyst layer 202 and the second semiconductor photocatalyst layer 203. By appropriately configuring the relationship between the band structure of the two semiconductor photocatalyst layers thus stacked, realized is the semiconductor photocatalyst layer 201 having a band structure advantageous for charge separation of carriers generated due to light absorption. For this reason, such a semiconductor photoelectrode has high quantum efficiency. In FIG. 6, the two semiconductor photocatalyst layers which are made of different semiconductor material to each other are stacked. However, the semiconductor photocatalyst layer 201 may be composed of three or more semiconductor photocatalyst layers.

A plurality of pillar protrusions formed on the surface of the semiconductor photoelectrode 200 scatter light incident on the surface of the semiconductor photoelectrode 200 and increase the light-absorption area on the semiconductor photoelectrode 200. For this reason, the light-absorption efficiency on the semiconductor photoelectrode 200 is improved, as compared to an electrode having a flat-and-smooth surface. Note that this effect can't be obtained by merely increasing a surface area of an electrode. For example, even if an agglomerate structure or a structure having secondary holes is used, the light-absorption efficiency is not improved, since light does not goes deeply into the hole. The “structure having a secondary hole” means a structure having a surface area increased by forming secondary holes in one hole. For this reason, it is desirable that a plurality of pillar protrusions as shown in FIG. 6 are arranged regularly in order to increase the light absorption efficiency. It is desirable that a distance between two adjacent pillar protrusions is not too narrow. Since the incident light goes deeply into the space of the two adjacent pillar protrusions due to a suitable distance between two adjacent pillar protrusions, the light-absorption efficiency is improved more. In particular, it is desirable that a suitable distance between two adjacent pillar protrusions is equal to or more than a wavelength of the light incident on the semiconductor photoelectrode 200.

The effect due to the pillar protrusions is provided more surely and positively by accurately controlling the arrangement and shape of the pillar protrusions. For example, as just described, a suitable distance between two adjacent pillar protrusions is provided. In addition, by forming pillar protrusions each having a finer projection-recess shape than a conventional semiconductor photoelectrode, a higher quantum efficiency than that of the conventional semiconductor photoelectrode having a projection-recess shape is realized. It is desirable that the distance between two adjacent pillar protrusions is not more than 5 micrometers. Three micrometers is more desirable. It is desirable that each pillar protrusion has an aspect ratio of not less than 2. The aspect ratio of not less than 4 is more desirable. The aspect ratio of not less than 10 is still more desirable. It is desirable that the plurality of the pillar protrusions are arranged regularly. It is desirable that a variability of the density of the pillar protrusions on the surface of the conductive substrate 102 is as small as possible. For example, at least one protrusion is provided per region having an area of 100 square micrometers on the surface of the conductive substrate 102. In the case where the aspect ratio of the pillar protrusion is high and the density of the pillar protrusion is high, since the effect of light scattering is improved and the light-absorption area is increased, the light-absorption efficiency is improved.

A liquid phase deposition method (hereinafter, referred to as “LPD method”) is suitable for the formation of the semiconductor photocatalyst layer 101 to control the arrangement and the shape of the pillar protrusions accurately as above stated and to maintain the complex surface shape thereof. The LPD method is, for example, comprises the following three processes. In the first process, the predetermined arrangement of the plurality of the pillar protrusions is patterned on a replica film. In the second process, the semiconductor photocatalyst layer 101 is formed on the patterned replica film by the LPD method. In the third process, an electric conductor, namely, the conductive substrate 102, is formed on the semiconductor photocatalyst layer 101. In this way, the semiconductor photoelectrode 200 can be fabricated.

The semiconductor photoelectrode 200 according to the present embodiment is fabricated as below. First, the semiconductor photocatalyst layer 101, namely, the first semiconductor photocatalyst layer 202, is formed by the LPD method on the conductive substrate 102 having a projection-recess shape on the surface thereof. Then, the second semiconductor photocatalyst layer 203 is formed by a sputtering method on the first semiconductor photocatalyst layer 202. In this way, the semiconductor photoelectrode 200 is fabricated. For more detail, see the example 1.

Japanese Patent Application Laid-open Publication No. 2006-297300 discloses a semiconductor photoelectrode having a projection-recess surface. Furthermore, Japanese Patent Application Laid-open Publication No. 2006-297300 discloses three methods for fabricating a semiconductor photoelectrode having a projection-recess surface. In the first method, the substrate is mechanically polished, and then the substrate is subjected to chemical etching. In the second method, metal particles are joined onto a metal substrate by applying pressure or heat. In the third method, a metal substrate patterned using a photoresist mask is etched.

However, projection-recess structure is formed randomly on the surface thereof in the first and second methods. For this reason, it is difficult to accurately control the distance between two adjacent pillar protrusions included in the projection-recess structure in the first and second methods. In the third method, the projection-recess structure is controlled technically; however, the third method causes high cost. For example, it is difficult to put the semiconductor photoelectrode obtained by the third method into practical use as a semiconductor photoelectrode for splitting water using solar energy. For this reason, it is difficult to form a semiconductor photoelectrode having a dense structure on the surface thereof in accordance with the disclosure of Japanese Patent Application Laid-open Publication No. 2006-297300.

On the other hand, for example, by fabricating the semiconductor photoelectrode 200 according to the present embodiment by a LPD method, problems in the conventional fabrication method of the semiconductor photoelectrode can be solved.

Since the semiconductor photoelectrode 200 according to the present embodiment has a plurality of pillar protrusions on the surface thereof, the semiconductor photoelectrode 200 according to the present embodiment has a larger surface area than an electrode having a flat-and-smooth surface. For this reason, the substantial current density of the flowing current is decreased. As a result, overvoltage is decreased. In this way, the reaction generated on the semiconductor photoelectrode 200 is promoted. For example, if the semiconductor photoelectrode 200 is used for water splitting, water splitting reaction is promoted.

Hereinafter, the present inventors discuss the relationship between the current density and the overvoltage in the reaction for splitting water using two electrodes.

Electrolysis of water requires a voltage of 1.23 volts theoretically. However, a voltage more than 1.23 volts is required for the electrolysis of water under a practicable current density. “Overvoltage” means voltage more than a theoretical value. The value of the overvoltage is varied depending on the material used for the electrode. The overvoltage is increased with an increase in the current density flowing through the electrode.

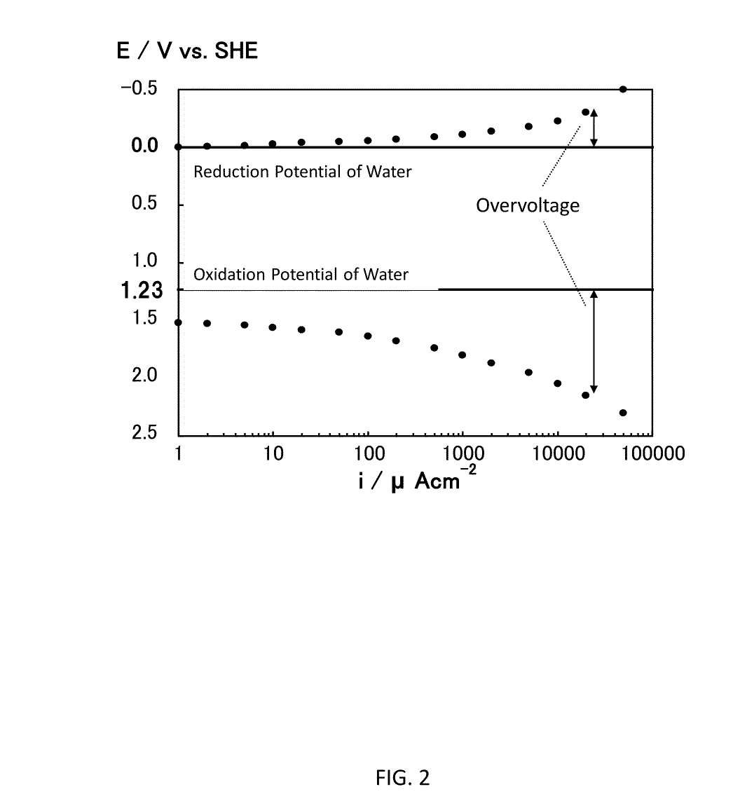

FIG. 2 shows a measurement result of a steady state polarization curve of water splitting using two flat-and-smooth platinum electrodes included in a dilute sulfuric acid aqueous solution. Since platinum has a high catalytic ability as an electrode for generating hydrogen, hydrogen is generated at a voltage of a theoretical electric potential. On the other hand, when platinum is used as an electrode for generating oxygen, a voltage more than theoretical voltage, namely, more than 1.23 volts, is required to generate oxygen. In other words, when platinum is used as an electrode for generating oxygen, overvoltage is high, as is clear from FIG. 2.

Then, the present inventors discuss the relationship between the current density and the overvoltage in the hydrogen generation using the semiconductor photoelectrode. The present inventors suppose in the following discussion that the following hypotheses (I)-(III) are true.

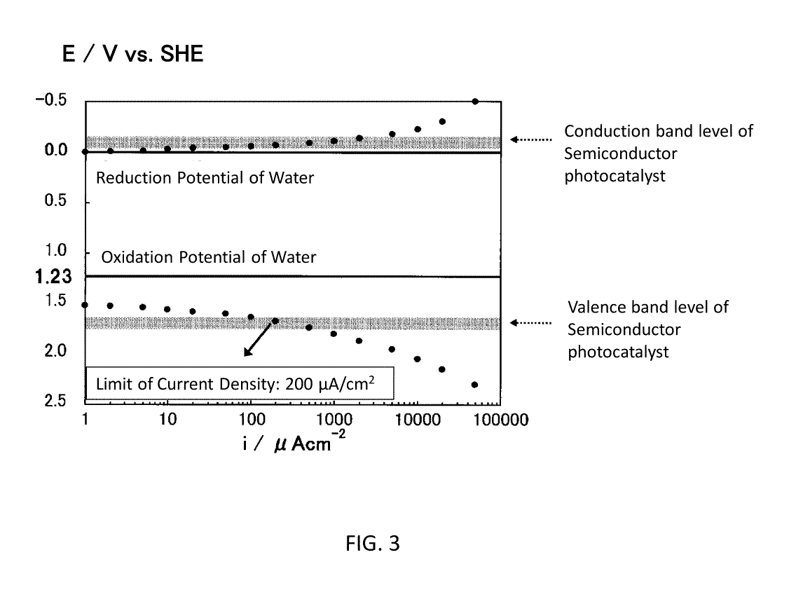

(I) The semiconductor photocatalyst used for the semiconductor photoelectrode has a band structure as shown in FIG. 3.

(II) The semiconductor photocatalyst used for the semiconductor photoelectrode absorbs all solar light having energy of not less than the bandgap.

(III) All the generated electrons and holes are used for water splitting.

In this case, the obtained current density is calculated to be approximately 24 mA/cm². If the bandgap is supposed to be 1.65 eV (750 nanometers), the obtained current is 23.9 mA/cm². See Smestad, G. P., Krebs, F. C., Lampert, C. M., Granqvist, C. G., Chopra, K. L., Mathew, X., & Takakura, H. “Reporting solar cell efficiencies in Solar Energy Materials and Solar Cells” Solar Energy Materials & Solar Cells, Vol. 92, (2008) 371-373.

When the present inventors suppose that the semiconductor photocatalyst has a catalytic ability equivalent to that of a platinum electrode, since an energy difference between valence band level and oxygen-generating level, which is oxidation potential of water, corresponds to the overvoltage in the oxygen-generating reaction, the limit of the current density in the case where oxygen is generated with a semiconductor photoelectrode using the semiconductor photocatalyst is believed to be approximately 0.2 mA/cm². Under such circumstances, even when all the light having energy of not less than the bandgap is absorbed, since the water splitting reaction generated on the surface of the semiconductor photoelectrode limits the reaction rate, the current density of approximately 24 mA/cm² failed to be obtained.

In order to solve such a problem, a projection-recess structure can be formed on the surface of the semiconductor photoelectrode. Since the current density and the overvoltage are substantially decreased with an increase in the reaction area of the electrode, the water splitting reaction progress under a greater current density, as compared to the case using a flat-and-smooth electrode. For this reason, in order to generate hydrogen with high efficiency, it is important to control the surface structure of the semiconductor photoelectrode and to increase the surface area of the semiconductor photoelectrode.

Hereinafter, the present inventors discuss a case where the light source for optically generating hydrogen is sunlight. When the light source is sunlight, the current density that can flow to generate hydrogen optically on the semiconductor photocatalyst is unambiguously calculated from the bandgap of the semiconductor photocatalyst. For this reason, the surface area necessary to achieve the current density that can flow to generate hydrogen optically on the semiconductor photocatalyst can be estimated from the catalytic ability of the semiconductor photocatalyst and the overvoltage. For example, it is necessary to enlarge the surface area of the semiconductor photocatalyst around equal to or more than one hundred times to obtain the current density of approximately 24 mA/cm² using a semiconductor photocatalyst having a catalytic ability equal to that of the Pt electrode and having a bandgap shown in FIG. 3.

Various structures are suggested to enlarge the reaction area of the semiconductor photoelectrode. For example, when the semiconductor photoelectrode is formed of TiO₂, a titania nanotube (hereinafter, referred to as “TNT”) structure provided by anodizing a Ti substrate is exemplified. Since an electrode having a TNT structure (hereinafter, referred to as “TNT electrode”) has a structure where a plurality of tubes each having a diameter of around some hundred nanometers and made of TiO₂ are arranged densely on the surface of the Ti substrate, the TNT structure has a larger surface area than a flat-and-smooth electrode. However, the distance between the upper end of the TNT and the Ti substrate increases, when the length of the TNT is increased to enlarge the surface area.

When the semiconductor photoelectrode is irradiated with light, a lot of pairs of electrons and holes are generated near the surface of the semiconductor photoelectrode. For this reason, the probability of the recombination between these electrons and holes is required to be decreased in order to generate hydrogen optically with high efficiency. However, since the TNT electrode has a long distance from the upper end of the TNT to the Ti substrate, the migration distance of the generated electrons is also long. For this reason, this causes a problem that the reaction efficiency is decreased due to increase of the probability of the recombination between electrons and holes.

On the other hand, in the present first embodiment, pillar protrusions used for forming a projection-recess structure on the surface of the semiconductor photoelectrode 200 are formed on the surface of the conductive substrate 102. Then, the first semiconductor photocatalyst layer 202 and the second semiconductor photocatalyst layer 203 are disposed on the surface of the conductive substrate 102. For this reason, the distance between the second semiconductor photocatalyst layer 203 and the conductive substrate 102 is equal to the thickness of the first semiconductor photocatalyst layer 202 irrespective of aspect ratio, even if the aspect ratio of the pillar protrusion is increased to enlarge the surface area. For this reason, the migration distance of the electrons generated in the second semiconductor photocatalyst layer 203 is minimized. In this way, by using the semiconductor photoelectrode 200, the probability of the recombination between the electrons and the holes is decreased, while the surface area is enlarged. For this reason, hydrogen is generated optically with high efficiency.

The first semiconductor photocatalyst layer 202 has a thickness of not less than 10 nanometers and not more than 100 nanometers. Since the first semiconductor photocatalyst layer 202 has a thickness that falls within this range, both the internal quantum efficiency and the external quantum efficiency improve. The internal quantum efficiency improves significantly. The term “quantum efficiency” used in the instant specification includes the term “external quantum efficiency” and the term “internal quantum efficiency”. In the instant specification, these two kinds of quantum efficiencies are defined as below.

The term “external quantum efficiency” is defined as a rate of the number of the electrons extracted as the photocurrent to the number of the photons incident on the semiconductor photoelectrode. The external quantum efficiency is an index usable for analyzing how much the photons incident on the semiconductor photoelectrode from the light source contribute as the photocurrent.

The term “internal quantum efficiency” is defined as a rate of the number of the electrons extracted as the photocurrent to the number of the photons absorbed by the semiconductor photoelectrode. The internal quantum efficiency is usable as an index for analyzing how much the carriers generated on or injected into the semiconductor photocatalyst layer contribute as the photocurrent.

Then, the materials of the conductive substrate 102 and the first semiconductor photocatalyst layer 202 will be described.

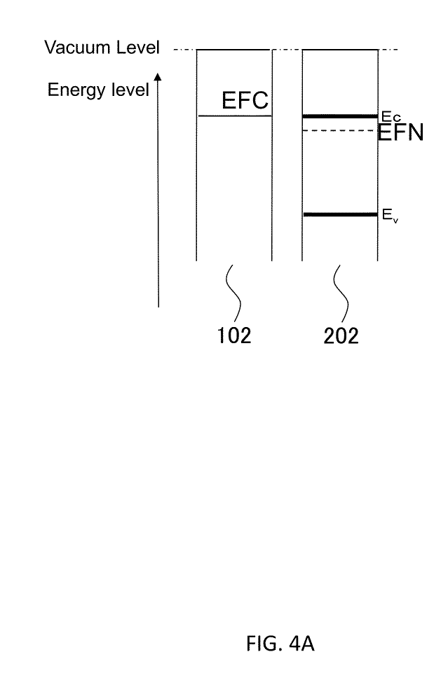

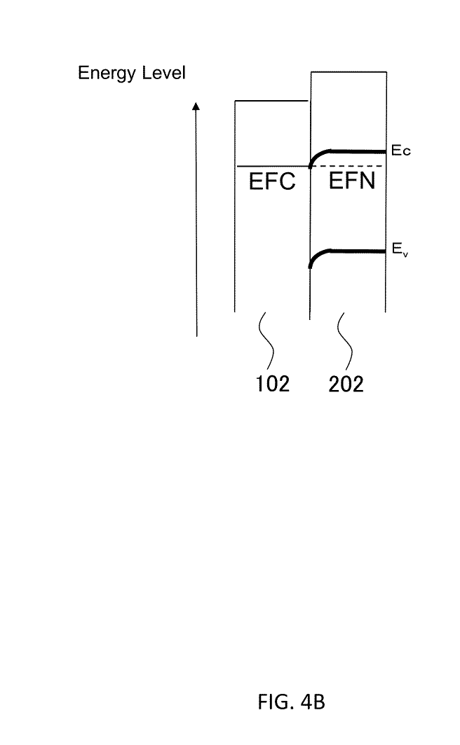

The materials of the conductive substrate 102 are not limited, as long as the materials of the conductive substrate 102 are metal. The conductive substrate 102 is fabricated using materials which form ohmic contact with the first semiconductor photocatalyst layer 202 to be formed thereon. For this reason, it is desirable that the energy difference between the vacuum level and the Fermi level of the conductive substrate 102 is smaller than the energy difference between the vacuum level and the Fermi level of the first semiconductor photocatalyst layer 202, when the first semiconductor photocatalyst layer 202 is made of n-type semiconductor. These relations are described with reference to FIG. 4A and FIG. 4B.

FIG. 4A shows a band structure before the conductive substrate 102 and the first semiconductor photocatalyst layer 202 form the junction. FIG. 4B shows a band structure after the conductive substrate 102 and the first semiconductor photocatalyst layer 202 have formed the junction. In the drawings, Ec means the bottom of the conduction band of the n-type semiconductor which forms the first semiconductor photocatalyst layer 202. Ev means the top of the valence band of the n-type semiconductor.

As shown in FIG. 4A, in the case where the conductive substrate 102 and the first semiconductor photocatalyst layer 202 do not form the junction, the energy difference between the vacuum level and the Fermi level of the conductive substrate 102 (hereinafter, referred to as “EFC”) is smaller than the energy difference between the vacuum level and the Fermi level of the first semiconductor photocatalyst layer 202 (hereinafter, referred to as “EFN”). When the conductive substrate 102 and the first semiconductor photocatalyst layer 202 form the junction under the condition where such a positional relationship of the Fermi level is satisfied, carriers transfer in such a manner that these Fermi levels are equal to each other at the junction plane therebetween. As a result, the edge of the band is bent as shown in FIG. 4B. In this case, a Schottky barrier does not occur in the first semiconductor photocatalyst layer 202, and an ohmic contact is formed between the first semiconductor photocatalyst layer 202 and the conductive substrate 102. Since the ohmic contact is formed between the first semiconductor photocatalyst layer 202 and the conductive substrate 102, the migration of the electrons from the first semiconductor photocatalyst layer 202 to the conductive substrate 102 is not disturbed by the Schottky barrier. For this reason, the efficiency of the charge separation in the semiconductor photoelectrode 200 is improved, and the semiconductor photoelectrode 200 has high quantum efficiency.

The conductive substrate 102 may be composed of a plurality of metal layers. In this case, it is desirable that a metal thin film having a small work function is used as an uppermost metal layer which forms a junction with the first semiconductor photocatalyst layer 202 so as to form an ohmic contact between the conductive substrate 102 and the first semiconductor photocatalyst layer 202. An example of the material of the uppermost metal layer is Al, Ti, V, Zr, Nb, Ag, In, or Ta.

The material of the first semiconductor photocatalyst layer 202 is appropriately selected from semiconductor photocatalyst materials capable of forming an ohmic contact with the conductive substrate 102 and having a band structure suitable for the utility of the semiconductor photoelectrode 200, namely, suitable for the reaction generated on the semiconductor photoelectrode 200. For example, if the semiconductor photoelectrode 200 is used for water splitting, the following materials are selected to generate hydrogen by splitting water photoelectrochemically. The bottom of the conduction band of the semiconductor material is not more than 0 volts. For example, the bottom of the conduction band of the semiconductor material is −0.1 volt. The standard reduction potential of water is equal to 0 volts. The top of the valence band of the semiconductor material is not less than 1.23 volts. For example, the top of the valence band of the semiconductor material is 1.24 volts. The standard oxidation potential of water is equal to 1.23 volts. In this case, it is desirable that the first semiconductor photocatalyst layer 202 is formed of at least one compound selected from the group consisting of oxide, nitride, and oxynitride, and that the at least one compound contains at least one element selected from the group consisting of Ti, Nb, and Ta. Such a material is poorly dissolved in an electrolyte solution and used for the semiconductor photoelectrode capable of splitting water using light such as sunlight.

An example of the combination of the first semiconductor photocatalyst layer 202 and the conductive substrate 102 both of which can form an ohmic contact is TiO₂/Ti, Nb₂O₅/Ti, Ta₂O₅/Ti, TiO₂/Nb, Nb₂O₅/Nb, Ta₂O₅/Nb, TiO₂/Ta, Nb₂O₅/Ta, or Ta₂O₅/Ta.

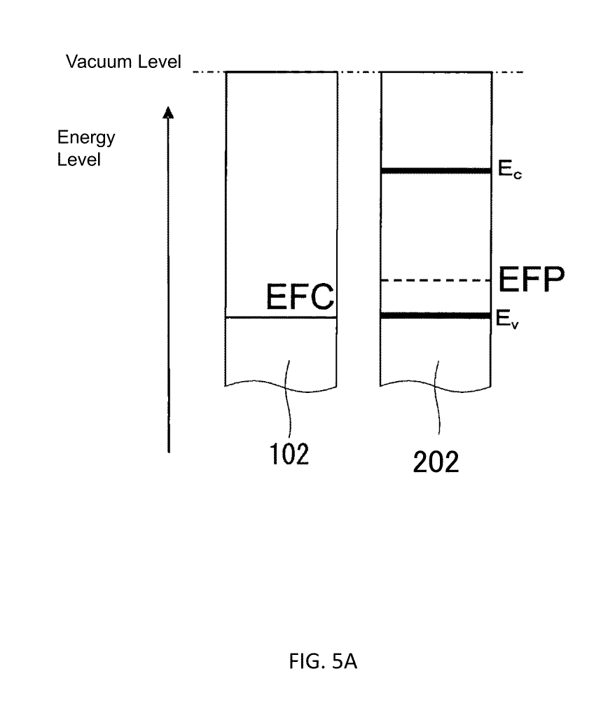

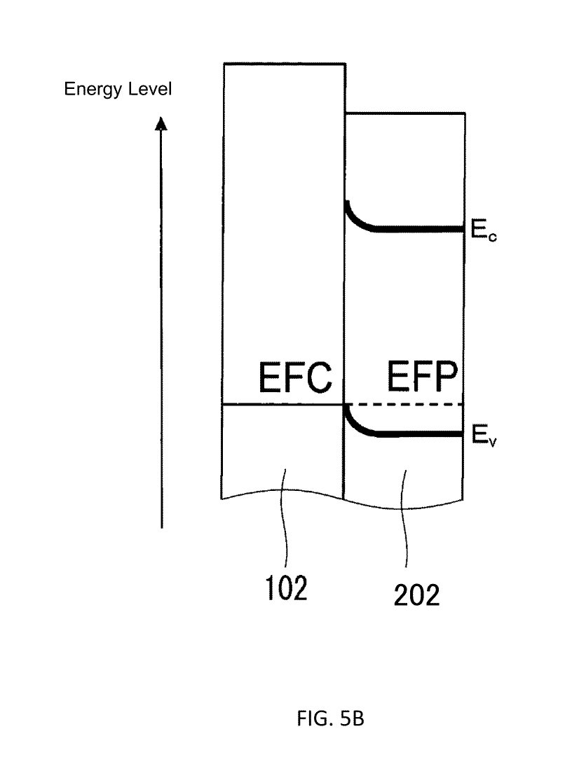

If the first semiconductor photocatalyst layer 202 is composed of p-type semiconductor, it is desirable that the energy difference between the vacuum level and the Fermi level of the conductive substrate 102 is greater than the energy difference between the vacuum level and the Fermi level of the first semiconductor photocatalyst layer 202. These relations are described with reference to FIG. 5A and FIG. 5B.

As shown in FIG. 5A, the energy difference between the vacuum level and the Fermi level of the conductive substrate 102 (EFC) is greater than the energy difference between the vacuum level and the Fermi level of the first semiconductor photocatalyst layer 202 (EFP), before the conductive substrate 102 and the first semiconductor photocatalyst layer 202 form the junction therebetween. When the conductive substrate 102 and the first semiconductor photocatalyst layer 202 form the junction under the condition where such a positional relationship of the Fermi level is satisfied, carriers transfer in such a manner that these Fermi levels are equal to each other at the junction plane therebetween. As a result, the edge of the band is bent as shown in FIG. 5B. In this case, a Schottky barrier does not occur in the first semiconductor photocatalyst layer 202, and an ohmic contact is formed between the first semiconductor photocatalyst layer 202 and the conductive substrate 102. Since the ohmic contact is formed between the first semiconductor photocatalyst layer 202 and the conductive substrate 102, the migration of the holes from the first semiconductor photocatalyst layer 202 to the conductive substrate 102 is not disturbed by the Schottky barrier. For this reason, the efficiency of the charge separation in the semiconductor photoelectrode 200 is improved, and the semiconductor photoelectrode 200 has high quantum efficiency.

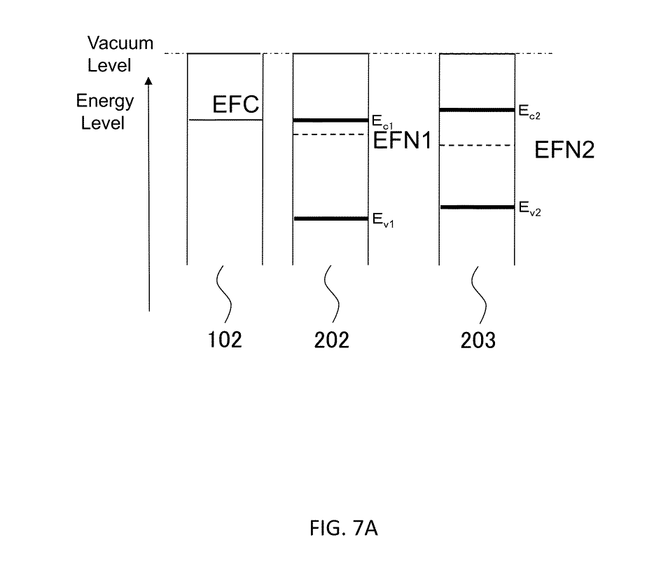

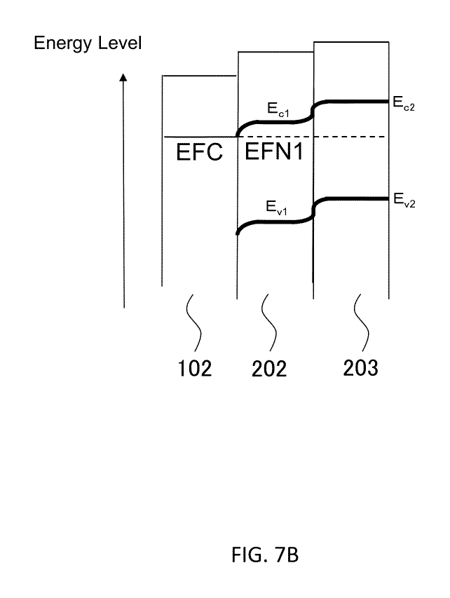

FIG. 7A shows a band structure before the conductive substrate 102, the first semiconductor photocatalyst layer 202, and the second semiconductor photocatalyst layer 203 form the junction in a case where both the first semiconductor photocatalyst layer 202 and the second semiconductor photocatalyst layer 203 are made of n-type semiconductor. FIG. 7B shows a band structure after the conductive substrate 102, the first semiconductor photocatalyst layer 202, and the second semiconductor photocatalyst layer 203 have formed the junction in a case where both the first semiconductor photocatalyst layer 202 and the second semiconductor photocatalyst layer 203 are made of n-type semiconductor. In the drawings, Ec1 and Ec2 mean the bottoms of the conduction bands of the first semiconductor photocatalyst layer 202 and the second semiconductor photocatalyst layer 203, respectively. Ev1 and Ev2 mean the tops of the valence bands of the first semiconductor photocatalyst layer 202 and the second semiconductor photocatalyst layer 203, respectively.

As shown in FIG. 6, the semiconductor photocatalyst layer 201 has a structure where the second semiconductor photocatalyst layer 203 is stacked on the first semiconductor photocatalyst layer 202. As shown in FIG. 7A, in the case where both the first semiconductor photocatalyst layer 202 and the second semiconductor photocatalyst layer 203 are made of n-type semiconductor, before the junction is not yet formed, it is desirable that the following relations (i)-(iv) are satisfied.

(i) The energy difference between the vacuum level and the Fermi level of the conductive substrate 102 (EFC) is smaller than the energy difference between the vacuum level and the Fermi level of the first semiconductor photocatalyst layer 202 (EFN1).

(ii) The energy difference between the vacuum level and the Fermi level of the first semiconductor photocatalyst layer 202 (EFN1) is smaller than the energy difference between the vacuum level and the Fermi level of the second semiconductor photocatalyst layer 203 (EFN2).

(iii) The energy difference between the vacuum level and the top Ev1 of the valence band of the first semiconductor photocatalyst layer 202 is greater than the energy difference between the vacuum level and the top Ev2 of the valence band of the second semiconductor photocatalyst layer 203.

(iv) The energy difference between the vacuum level and the bottom Ec1 of the conduction band of the first semiconductor photocatalyst layer 202 is greater than the energy difference between the vacuum level and the bottom Ec2 of the conduction band of the second semiconductor photocatalyst layer 203.

As shown in FIG. 7B, after the conductive substrate 102, the first semiconductor photocatalyst layer 202, and the second semiconductor photocatalyst layer 203 which satisfy the (i)-(iv) relations have formed the junction, a band bending advantageous for the charge separation is formed at the junction plane between the first semiconductor photocatalyst layer 202 and the second semiconductor photocatalyst layer 203, and an ohmic contact is formed at the junction plane between the conductive substrate 102 and the first semiconductor photocatalyst layer 202. For this reason, since the charge separation of the carriers generated in the second semiconductor photocatalyst layer 203 due to light-absorption is performed efficiently, the semiconductor photoelectrode 200 has high quantum efficiency.

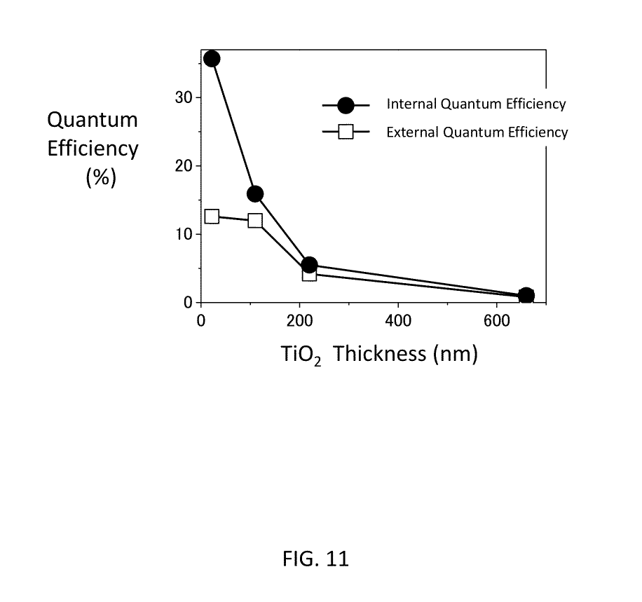

The first semiconductor photocatalyst layer 202 also has a thickness of not less than 10 nanometers and not more than 100 nanometers in the embodiment shown in FIG. 6. Desirably, the first semiconductor photocatalyst layer 202 has a thickness of not less than 10 nanometers and not more than 80 nanometers. As understood from FIG. 11, when the first semiconductor photocatalyst layer 202 has a thickness of not more than 80 nanometers, the internal quantum efficiency is more than approximately 20 percent. The first semiconductor photocatalyst layer 202 serves as a charge separation layer, however, since the first semiconductor photocatalyst layer 202 has a thickness of not less than 10 nanometers and not more than 100 nanometers, the first semiconductor photocatalyst layer 202 fulfills a function of the charge separation adequately. In order not to generate the recombination during the migration of the electrons generated due to light absorption, it is desirable that the first semiconductor photocatalyst layer 202 is as thin as possible.

It is desirable that the materials of the first semiconductor photocatalyst layer 202 and the second semiconductor photocatalyst layer 203 satisfy the above-mentioned (i)-(iv) relations. It is desirable that the first semiconductor photocatalyst layer 202 and the second semiconductor photocatalyst layer 203 are also formed of at least one compound selected from the group consisting of oxide, nitride and oxynitride, and that the at least one compound contains at least one element selected from the group consisting of Ti, Nb, and Ta. Such a material is poorly dissolved in an electrolyte solution and used for the semiconductor photoelectrode capable of splitting water with light such as sunlight.

An example of the combination of the materials of the second semiconductor photocatalyst layer 203, the first semiconductor photocatalyst layer 202, and the conductive substrate 102 (i.e., the second semiconductor photocatalyst layer/the first semiconductor photocatalyst layer/the conductive substrate) is Nb₃N₅/TiO₂/Ti, Nb₃N₅/Nb₂O₅/Ti, Nb₃N₅/Ta₂O₅/Ti, Nb₃N₅/TiO₂/Nb, Nb₃N₅/Nb₂O₅/Nb, Nb₃N₅/Ta₂O₅/Nb, Nb₃N₅/TiO₂/Ta, Nb₃N₅/Nb₂O₅/Ta, Nb₃N₅/Ta₂O₅/Ta, NbON/TiO₂/Ti, NbON/Nb₂O₅/Ti, NbON/Ta₂O₅/Ti, NbON/TiO₂/Nb, NbON/Nb₂O₅/Nb, NbON/Ta₂O₅/Nb, NbON/TiO₂/Ta, NbON/Nb₂O₅/Ta, or NbON/Ta₂O₅/Ta. Regarding Nb₃N₅, See WO 2013/084447. WO 2013/084447 is equivalent to U.S. patent application Ser. No. 13/983,729, the entire contents of which is hereby incorporated by reference. Regarding NbON, see the example 1, which is described later. NbON means Nb_{c}O_{d}Nₑ (where c=d=e=1).

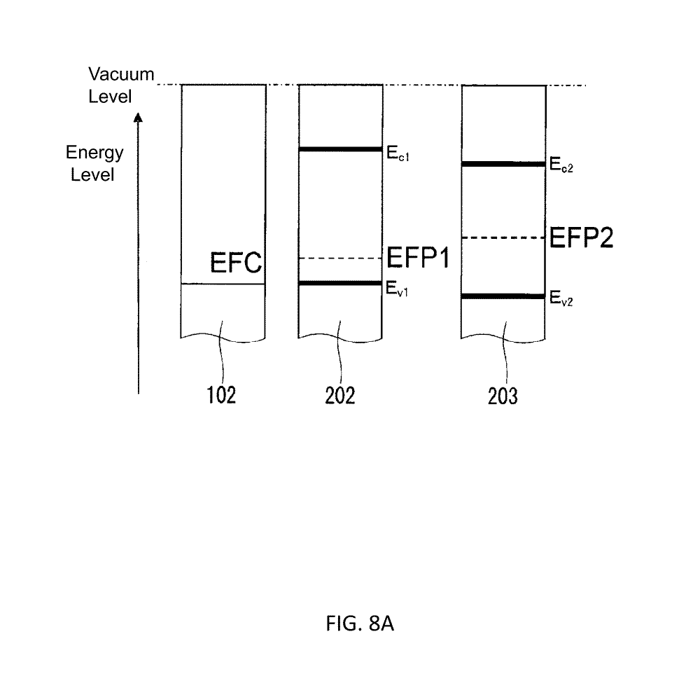

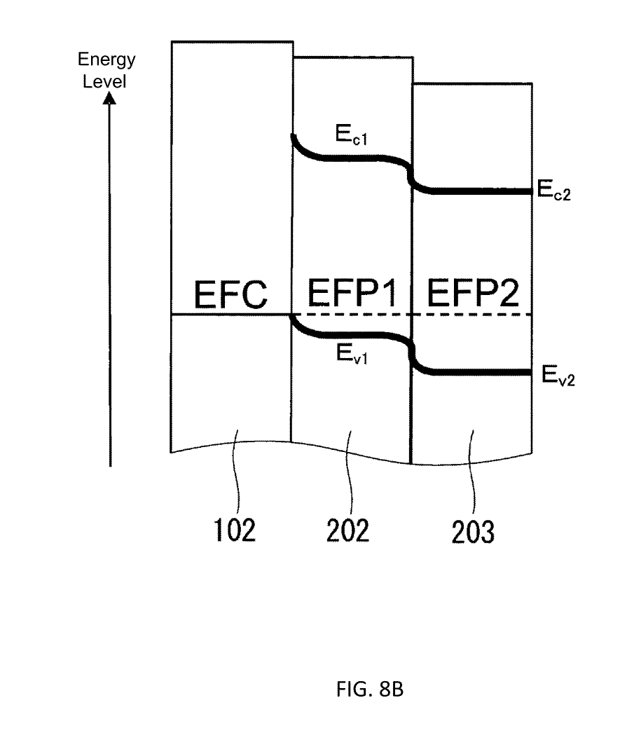

In a case where the first semiconductor photocatalyst layer 202 and the second semiconductor photocatalyst layer 203 are made of p-type semiconductor, as shown in FIG. 8A, before these layers form the junction, it is desirable that the following relations (I)-(IV) are satisfied.

(I) The energy difference between the vacuum level and the Fermi level of the conductive substrate 102 (EFC) is greater than the energy difference between the vacuum level and the Fermi level of the first semiconductor photocatalyst layer 202 (EFP1).

(II) The energy difference between the vacuum level and the Fermi level of the first semiconductor photocatalyst layer 202 (EFP1) is greater than the energy difference between the vacuum level and the Fermi level of the second semiconductor photocatalyst layer 203 (EFP2).

(III) The energy difference between the vacuum level and the top Ev1 of the valence band of the first semiconductor photocatalyst layer 202 is smaller than the energy difference between the vacuum level and the top Ev2 of the valence band of the second semiconductor photocatalyst layer 203.

(IV) The energy difference between the vacuum level and the bottom Ec1 of the conduction band of the first semiconductor photocatalyst layer 202 is smaller than the energy difference between the vacuum level and the bottom Ec2 of the conduction band of the second semiconductor photocatalyst layer 203.

As shown in FIG. 8B, after the conductive substrate 102, the first semiconductor photocatalyst layer 202, and the second semiconductor photocatalyst layer 203 which satisfy the (I)-(IV) relations have formed the junction, a band bending advantageous for the charge separation is formed at the junction plane between the first semiconductor photocatalyst layer 202 and the second semiconductor photocatalyst layer 203. An ohmic contact is formed at the junction plane between the conductive substrate 102 and the first semiconductor photocatalyst layer 202. For this reason, since the charge separation of the carriers generated in the second semiconductor photocatalyst layer 203 due to light-absorption is performed efficiently, the semiconductor photoelectrode 200 has high quantum efficiency.

(Still More Desirable Semiconductor Photoelectrode)

Next, a still more desirable semiconductor photoelectrode 200 according to the present first embodiment will be described below.

As shown in FIG. 6, the still more desirable semiconductor photoelectrode 200 according to the present first embodiment comprises the conductive substrate 102 made of niobium, the first semiconductor photocatalyst layer 202 made of niobium oxide represented by the chemical formula Nb₂O₅, and the second semiconductor photocatalyst layer 203 made of niobium nitride represented by the chemical formula Nb₃N₅.

An incident light is absorbed by niobium nitride represented by the chemical formula Nb₃N₅ included in the second semiconductor photocatalyst layer 203 to generate electrons and holes. Since niobium nitride represented by the chemical formula Nb₃N₅ has a bandgap of approximately 780 nanometers, almost all the portion of the incident visible light can be used for the generation of hydrogen due through water splitting. Since water splitting requires some overvoltage for both hydrogen generation reaction and oxygen generation reaction, it is desirable that the second semiconductor photocatalyst layer 203 has a bandgap of not less than approximately 780 nanometers for high efficiency. For this reason, it is believed that niobium nitride represented by the chemical formula Nb₃N₅ is most suitable for the material of the second semiconductor photocatalyst layer 203.

The first semiconductor photocatalyst layer 202 forms the band bending suitable for the separation of the electrons and the holes generated in the niobium nitride represented by the chemical formula Nb₃N₅, and has a role of a path for the electrons transferring to the conductive substrate 102. For this reason, from a viewpoint of the Fermi level, the position of the bottom of the conduction band, and the position of the top of the valence band, and from a viewpoint that the second semiconductor photocatalyst layer 203 is made of niobium nitride represented by the chemical formula Nb₃N₅, it is believed that niobium oxide represented by the chemical formula Nb₂O₅ is most suitable for the material of the first semiconductor photocatalyst layer 202. It is desirable that the first semiconductor photocatalyst layer 202 is as thin as possible to decrease the probability of the recombination between the electrons transferring in the first semiconductor photocatalyst layer 202 and the holes. In light of an actual fabrication process, it is desirable that the first semiconductor photocatalyst layer 202 has a thickness of not less than 10 nanometers and not more than 100 nanometers.

The conductive substrate 102 is required to form an ohmic contact with the first semiconductor photocatalyst layer 202 made of niobium oxide represented by the chemical formula Nb₂O₅. For this reason, from a viewpoint of the work function, and from a viewpoint of the process for forming the first semiconductor photocatalyst layer 202 made of niobium oxide represented by the chemical formula Nb₂O₅, it is believed that niobium is most suitable for the material of the conductive substrate 102.

As described above, the still more desirable semiconductor photoelectrode 200 comprises the conductive substrate 102 made of niobium, the first semiconductor photocatalyst layer 202 made of niobium oxide represented by the chemical formula Nb₂O₅, and the second semiconductor photocatalyst layer 203 made of niobium nitride represented by the chemical formula Nb₃N₅.

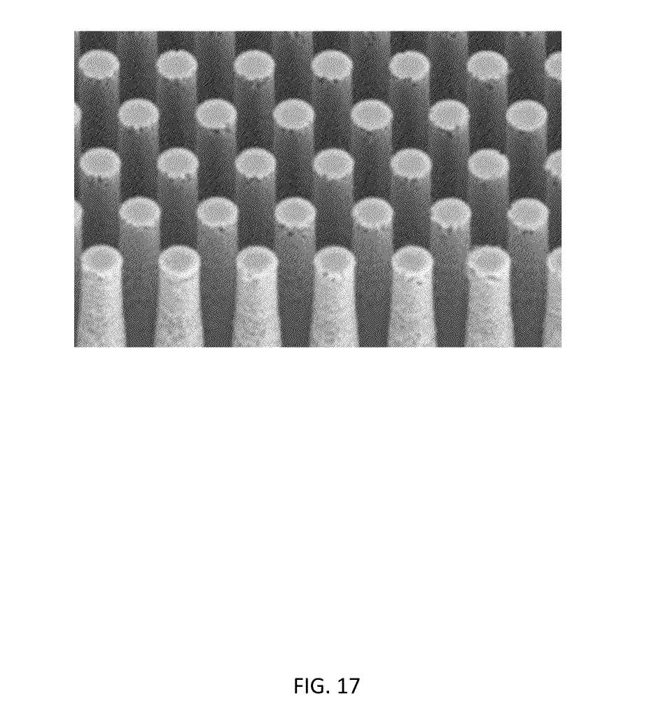

As shown in FIG. 17, each pillar protrusion formed on the surface of the semiconductor photoelectrode 200 may have a shape of a circular cylinder, a circular cone, a circular truncated corn, an ellipse, an elliptic cylinder, an elliptic cylinder cone, an elliptic truncated corn, a polygonal column, a polygonal columnar cone, or a polygonal truncated cone. It is desirable to be a shape of a circular cylinder. An example of the polygonal column is a triangular prism, a quadrangular prism, a pentagonal prism, or a hexagonal prism. An example of the polygonal columnar cone is a triangular pyramid, a quadrangular pyramid, a pentagonal pyramid, or a hexagonal pyramid.

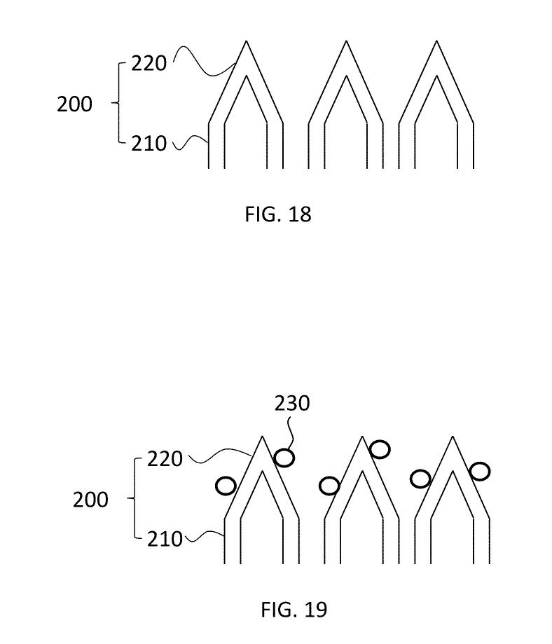

As shown in FIG. 18, it is desirable that the plurality of the pillar protrusions formed on the surface of the semiconductor photoelectrode 200 are each composed of a circular or polygonal columnar stem 210 and a top end 220 which has a shape of a cone or a truncated cone. In other words, it is desirable that the top end 220 of each pillar protrusion sharpens. Unlike in a case where each pillar protrusion is formed only of a circular or polygonal columnar stem, if each pillar protrusion has the top end 220 having a shape of a cone or a truncated cone, as shown in FIG. 18, portion of light incident on the top end 220 is reflected off the top end 220 to reach the surface of another pillar protrusion. In this way, the incident light can be used more efficiently.

As shown in FIG. 19, each pillar protrusion may comprise a light scattering particle 230 on the surface thereof. The light incident on the light scattering particle 230 is scattered on the light scattering particle 230 to reach the surface of another pillar protrusion. In this way, the incident light can be used more efficiently. An example of the light scattering particle 230 is a particle made of SiO₂.

In the semiconductor photoelectrode according to the first embodiment, the semiconductor photoelectrode has the plurality of the pillar protrusions on the surface thereof, and the surface of each pillar protrusion is formed of the second semiconductor photocatalyst layer 203. Since the light incident on the second semiconductor photocatalyst layer 203 is scattered, the ability of the second semiconductor photocatalyst layer 203 to absorb the light is improved, as compared to an electrode having a flat-and-smooth surface. In other words, the light incident on the surface of one pillar protrusion from an inclined direction with respect to the pillar protrusion is scattered to reach another pillar protrusion. In this way, the ability of the second semiconductor photocatalyst layer 203 to absorb the light is improved. Since the plurality of the pillar protrusions are provided, the semiconductor photoelectrode 200 has a larger area than a flat-and-smooth electrode. For this reason, a substantial current density of the flowing current can be decreased. As a result, an overvoltage can be lowered. In this way, the reaction which occurs on the electrode, for example, a water splitting reaction, is promoted. When the first semiconductor photocatalyst layer 202 has a significantly thin thickness of not less than 10 nanometers and not more than 100 nanometers, the probability of the recombination between the electrons and the holes generated due to the light absorption is significantly decreased to improve the quantum efficiency. Since the first semiconductor photocatalyst layer 202 forms an ohmic contact with the conductive substrate 102, the migration of the electrons from the first semiconductor photocatalyst layer 202 to the conductive substrate 102 is not disturbed by the Schottky barrier. Therefore, the quantum efficiency is more improved.

### Second Embodiment

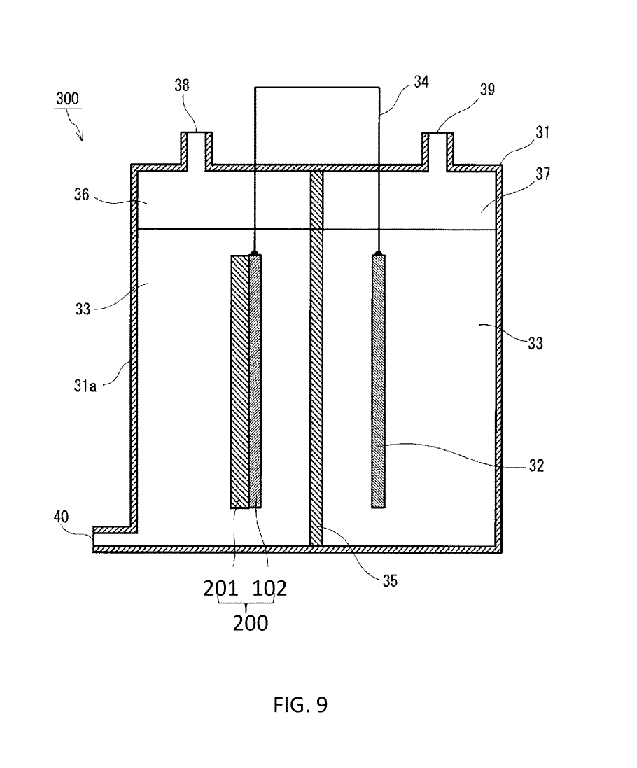

FIG. 9 shows a photoelectrochemical cell according to the second embodiment of the present invention. As shown in FIG. 9, the photoelectrochemical cell 300 according to the second embodiment comprises a container 31, a semiconductor photoelectrode 200, a counter electrode 32, and a separator 35. The semiconductor photoelectrode 200, the counter electrode 32, and the separator 35 are contained in the container 31. The inside of the container 31 is divided into a first chamber 36 and a second chamber 37 by the separator 35. The semiconductor photoelectrode 200 is disposed in the first chamber 36, whereas the counter electrode 32 is disposed in the second chamber 37. A liquid such as an aqueous electrolyte solution 33 is stored in both the first chamber 36 and the second chamber 37. The separator 35 is not need to be provided.

The semiconductor photoelectrode 200 is disposed in the first chamber 36 so as to be in contact with the aqueous electrolyte solution 33. The semiconductor photoelectrode 200 comprises the conductive substrate 102 having a surface where the plurality of the pillar protrusions are arranged, the first semiconductor photocatalyst layer 202 provided on the conductive substrate 102, and the second semiconductor photocatalyst layer 203. The conductive substrate 102, the first semiconductor photocatalyst layer 202, and the second semiconductor photocatalyst layer 203 are described in the first embodiment.

The first chamber 36 comprises a first outlet 38 for discharging oxygen generated in the first chamber 36 and an inlet 40 for supplying water to the first chamber 36. The container 31 is provided with a light-entrance portion 31a. The light-entrance portion 31a is disposed opposite to the second semiconductor photocatalyst layer 203 of the semiconductor photoelectrode 200 disposed in the first chamber 36. The light-entrance portion 31a is made of a material through which light such as sunlight can travel. In other words, the light-entrance portion 31a is transparent. An example of the material of the container 31 is Pyrex (registered trademark) glass or an acrylic resin.

The counter electrode 32 is disposed in the second chamber 37 so as to be in contact with the aqueous electrolyte solution 33. The second chamber 37 comprises a second outlet 39 for discharging hydrogen generated in the second chamber 37.

The conductive substrate 102 is electrically connected with the counter electrode 32 through an electric wire 34.

The conductive substrate 102, the first semiconductor photocatalyst layer 202, and the second semiconductor photocatalyst layer 203 included in the semiconductor photoelectrode 200 according to the second embodiment fulfill the effect similar to the effect described in the first embodiment.

The term “counter electrode” means an electrode for accepting electrons from the semiconductor photoelectrode without the electrolyte solution. As long as the counter electrode 32 is electrically connected with the conductive substrate 102 included in the semiconductor photoelectrode 200, a positional relation between the counter electrode 32 and the semiconductor photoelectrode 200 is not limited.

The aqueous electrolyte solution 33 has either acidity or alkalinity, as far as the aqueous electrolyte solution 33 is an aqueous electrolyte solution. Water may be used instead of the aqueous electrolyte solution. The aqueous electrolyte solution 33 is always stored in the container 31. Alternatively, the aqueous electrolyte solution 33 is supplied only in use. An example of the aqueous electrolyte solution 33 is dilute sulfuric acid, sodium sulfate, sodium carbonate, or sodium hydrogen carbonate.

The separator 35 is formed of a material capable of maintaining the aqueous electrolyte solution 33 transferable between the first chamber 36 and the second chamber 37, however, capable of stopping the flow of gas generated in the first chamber 36 and the second chamber 37. An example of the material of the separator 35 is a solid electrolyte such as a polymer electrolyte. An example of the polymer solid electrolyte is an ion-exchange membrane such as Nafion (registered trademark). Such a separator 35 allows the internal space of the container 31 to be divided into the first chamber 36 and the second chamber 37. The aqueous electrolyte solution 33 is in contact with the surface of the semiconductor photoelectrode 200, namely, the second semiconductor photocatalyst layer 203 in the first chamber 36. The aqueous electrolyte solution 33 is in contact with the surface of the counter electrode 32 in the second chamber 37. Such a structure allows hydrogen and oxygen generated in the container 31 to be divided easily.

The electric wire 34 is used for electrically connecting the counter electrode 32 with the conductive substrate 102. The electrons generated in the semiconductor photoelectrode 200 transfer through the electric wire 34 without applying an electric potential from the outside.

Next, how to use the photoelectrochemical cell 300 according to the second embodiment will be described below.

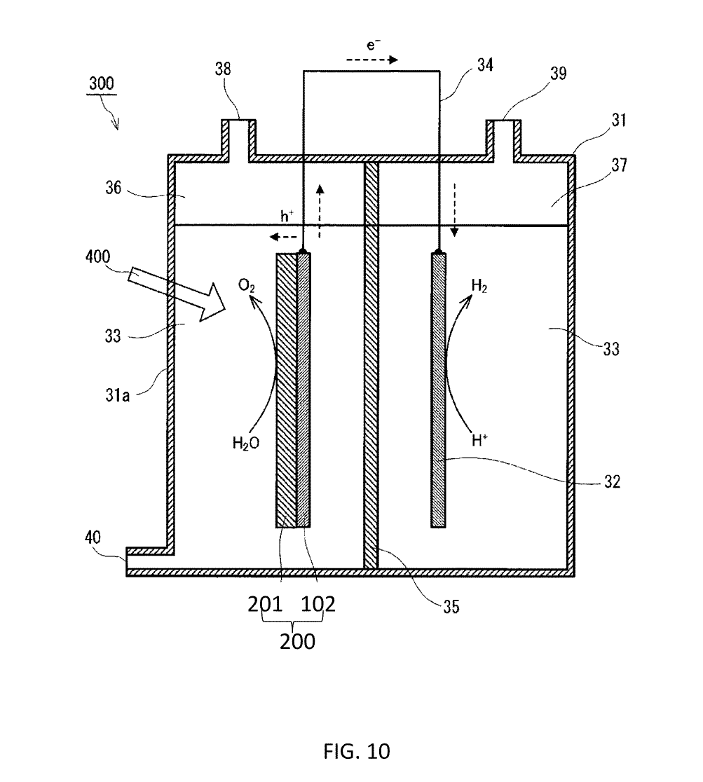

As shown in FIG. 10, the second semiconductor photocatalyst layer 203 included in the semiconductor photoelectrode 200 disposed in the container 31 is irradiated with light 400 such as sunlight through the light-entrance portion 31a. In the case where both the first semiconductor photocatalyst layer 202 and the second semiconductor photocatalyst layer 203 are made of n-type semiconductor, in the portion of the second semiconductor photocatalyst layer 203 irradiated with the light, the electrons and the holes are generated in the conduction band and in the valence band, respectively. The generated holes transfer to the surface of the second semiconductor photocatalyst layer 203. In this way, water is split as shown in the following reaction formula (V) on the surface of the second semiconductor photocatalyst layer 203. In this way, oxygen is generated.

4h⁺+2H₂O→O₂↑+4H⁺ (V)

where h⁺ represents a hole.

On the other hand, the electrons transfer to the conductive substrate 102 along the curve of the band edge of the conduction band of the first semiconductor photocatalyst layer 202 and the second semiconductor photocatalyst layer 203. The electrons which have transferred to the conductive substrate 102 further transfer through the conducting wire 34 to the counter electrode 32 electrically connected with the conductive substrate 102. In this way, hydrogen is generated as shown in the following reaction formula (VI) on the surface of the counter electrode 32.

4e⁻+4H⁺→2H₂↑ (VI)

Since the photoelectrochemical cell 300 according to the second embodiment comprises the semiconductor photoelectrode 200 described in the first embodiment, the photoelectrochemical cell 300 according to the second embodiment has high quantum efficiency for water splitting reaction.

### REFERENTIAL EXAMPLES

### Referential Example 1

In order to discuss a desirable thickness of the first semiconductor layer 202, a semiconductor photocatalyst layer formed of a TiO₂ film was used. The present inventors discussed the relationship between the thickness of the TiO₂ film and the quantum efficiency as below.

First, a TiO₂ film having a thickness of 22 nanometers was formed on a transparent electrode substrate made of indium tin oxide (hereinafter, referred to as “ITO”) by a sputtering method to provide a sample A1. Similarly, provided were samples A2, A3, and A4 having a TiO₂ film having a thickness of 110 nanometers, 220 nanometers, and 660 nanometers, respectively. Since the samples A1-A4 were used for discussion of the relationship between the semiconductor photocatalyst layer and the quantum efficiency, the transparent electrode substrate did not have pillar protrusions on the surface thereof. In other words, the surface of the transparent electrode substrate was flat-and-smooth.

The photocurrent of the samples A1-A4 was measured as below, and the quantum efficiencies of the samples A1-A4 were calculated. First, a container made of silica glass was prepared. A sulfuric acid aqueous solution having a concentration of 0.1M was supplied to this container as the aqueous electrolyte solution. One sample selected from the samples A1-A4 was disposed as the semiconductor photoelectrode in the container such that the one sample is brought into contact with the aqueous electrolyte solution. A platinum electrode was disposed as a counter electrode such that the platinum electrode was brought into contact with the aqueous electrolyte solution. Light from a xenon lamp (150 W) was dispersed using a diffracting grating to give monochromatic light having a wavelength of 300 nanometers. The sample which was in contact with the aqueous electrolyte solution was irradiated with this monochromatic light, and a current value flowing between the sample and the platinum electrode was measured using a potentiostat (available from Solartron, trade name: SI-1278).

The external quantum efficiency and the internal quantum efficiency were calculated as the quantum efficiency on the basis of the following mathematical formulae (VII) and (VIII), respectively.

(External quantum efficiency)=(the number of the electrons extracted as the photocurrent)/(the number of photons incident on the sample) (VII)

(Internal quantum efficiency)=(the number of the electrons extracted as the photocurrent)/(the number of photons absorbed in the sample) (VIII)

The number of the electrons extracted as the photocurrent was calculated by dividing the current value flowing between the sample and the platinum electrode by elementary charge (e: 1.602×10⁻¹⁹ (C)).

The number of the photons incident on the sample was calculated by measuring the energy of the light incident on the sample using a power meter (available from New Port Company, trade name: model 1931-c) and then by dividing the measured energy of the light by the energy per photon.

The number of the photons absorbed in the sample was calculated on the basis of the following mathematical formula (IX).

(The number of the photons absorbed in the sample)=(the absorptance A of the sample)·(the number of the photons incident on the sample) (IX)

The absorptance A of the sample was calculated on the basis of the following mathematical formula (X).

(The absorptance A of the sample)=1−(the transmittance T of the sample)−(the reflectance R of the sample) (X)

A method for measuring the absorptance A of the sample is described below.

First, fabricated was a sample where a semiconductor photocatalyst layer made of a TiO₂ film having the same thickness as the thickness of the semiconductor photoelectrode was formed on a sapphire substrate. The transmittance T and the reflectance R of the sample were measured with an UV-Vis spectrophotometer (available from JASCO Corporation, trade name: V-670) and an absolute reflectance measurement system (available from JASCO Corporation, trade name: ARMN-735), respectively.

The reason why the sapphire substrate was used is to eliminate the effect of the light absorption by the substrate when the transmittance T of the sample was measured. The sapphire substrate is transparent within a broad wavelength range. Since the sapphire substrate does not absorb light having a wavelength of 300 nanometers, it is suitably used as a substrate for measuring the transmittance T.

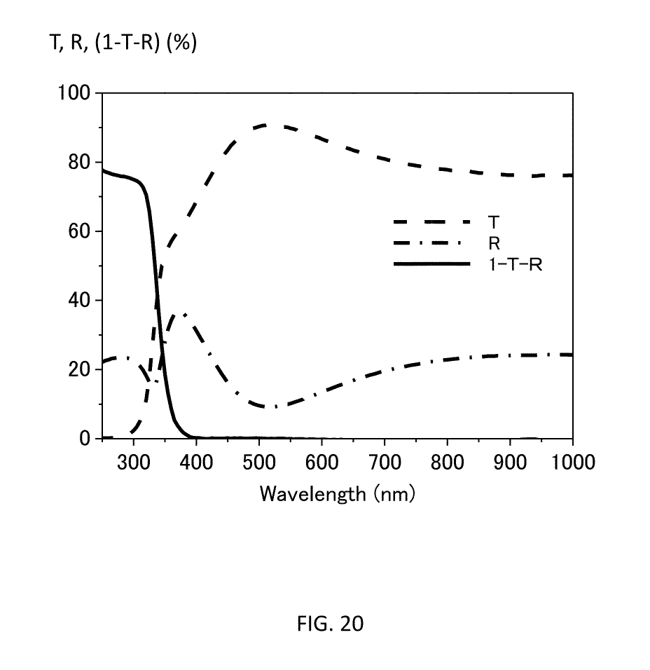

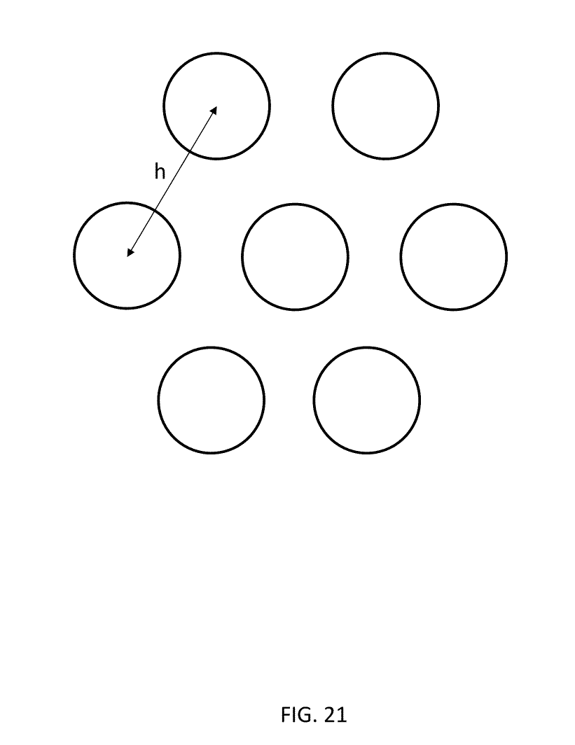

FIG. 20 shows an example of the transmittance T, the reflectance R, and the absorptance of the TiO₂ film having a thickness of 300 nanometers. In FIG. 20, the sapphire substrate having a thickness of 110 nanometers was used. Similarly, transmission factors T, reflectance rates R, and absorption ratios A of other TiO₂ films were calculated.

Table 1 and FIG. 11 show the results of the calculated external quantum efficiency and internal quantum efficiency.

TABLE 1

| | Thickness of | External | Internal |
|---|---|---|---|
| | the semiconductor | Quantum | Quantum |
| | photocatalyst layer | efficiency | efficiency |
| Sample | (nanometer) | (%) | (%) |
| A1 | 22 | 12.6 | 35.7 |
| A2 | 110 | 12.0 | 15.9 |
| A3 | 220 | 4.2 | 5.5 |
| A4 | 660 | 0.8 | 1.0 |

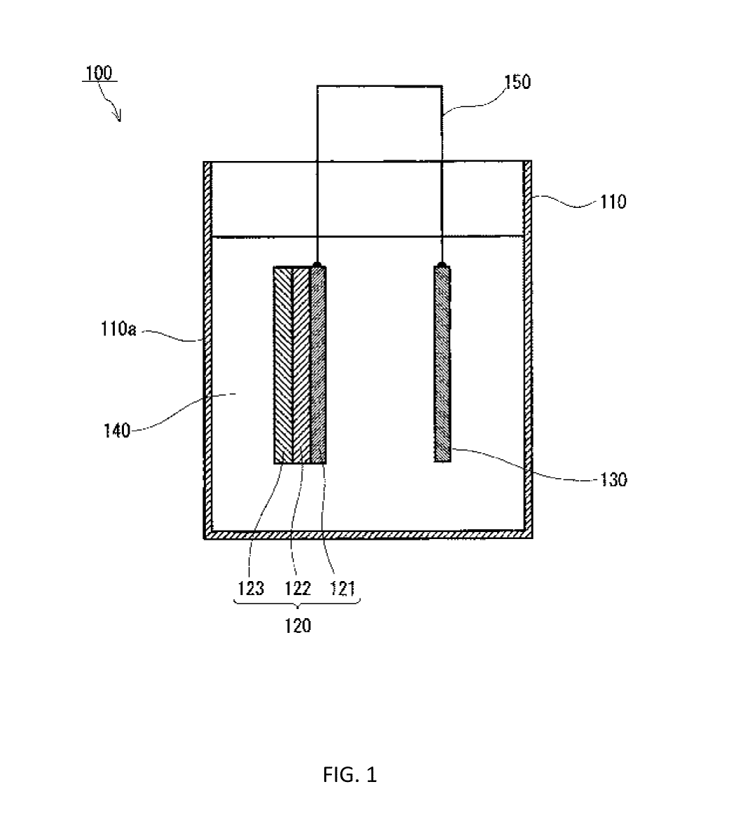

As is clear from Table 1, if the semiconductor photocatalyst layer has a thickness of not more than 110 nanometers, the external quantum efficiency is improved. On the other hand, the external quantum efficiency is decreased with an increase in the thickness of the semiconductor photocatalyst layer. The reason is believed to be that the efficiency of the light absorption is improved with an increase in the thickness of the semiconductor photocatalyst layer; however, the probability of the recombination is increased, since the migration distance of the electrons generated in the semiconductor photocatalyst layer to the electric conductor made of ITO is increased. The results shown in FIG. 1 reveal that, when the semiconductor photocatalyst layer is formed of one semiconductor material, the thickness optimum for surely maximizing the external quantum efficiency of the semiconductor photoelectrode is not more than 100 nanometers.

On the other hand, when the semiconductor photoelectrode is actually fabricated, if the semiconductor photocatalyst layer is too thin, a pin-hole is generated in the semiconductor photocatalyst layer. When the semiconductor photoelectrode is used, such a pinhole causes a failure. For this reason, when the semiconductor photocatalyst layer is formed of one semiconductor material, it is desirable that the semiconductor photocatalyst layer has a thickness of not less than 10 nanometers and not more than 100 nanometers in order to surely maximize the external quantum efficiency of the semiconductor photoelectrode.

When the semiconductor photocatalyst layer has a thickness of not more than 110 nanometers, the internal quantum efficiency is increased sharply. When the semiconductor photocatalyst layer has a thickness of 22 nanometers, the internal quantum efficiency is increased significantly. The reason is that the probability of the recombination is significantly decreased, since the migration distance of the electron generated in the thin semiconductor photocatalyst layer is short. For this reason, also from a viewpoint of the internal quantum efficiency, it is desirable that the semiconductor photocatalyst layer has a thickness of not more than 100 nanometers.

Next, the present inventors discuss the case where the semiconductor photocatalyst layer is formed of two semiconductor layers, as shown in FIG. 6. Since the first semiconductor photocatalyst layer 202 is not exposed on the surface of the semiconductor photoelectrode 200, the first semiconductor photocatalyst layer 202 hardly contributes to light-absorption. The first semiconductor photocatalyst layer 202 functions as a charge-separation layer for forming a band bending optimum for charge-separation. In other words, the first semiconductor photocatalyst layer 202 is a path for the electrons which are generated in the second semiconductor photocatalyst layer 203 and which travel to the conductive substrate 102. For this reason, it is believed that the quantum efficiency as the semiconductor photoelectrode is increased with an increase in the internal quantum efficiency of the first semiconductor photocatalyst layer 202. Hence, when the semiconductor photocatalyst layer is formed of two kinds of semiconductor materials, it is desirable that the first semiconductor photocatalyst layer has a thickness of not more than 100 nanometers.

On the other hand, the semiconductor photocatalyst layer has a thickness of not less than 10 nanometers to avoid the failure. For this reason, when the semiconductor photocatalyst layer is formed of two kinds of semiconductor materials, it is desirable that the first semiconductor photocatalyst layer has a thickness of not less than 10 nanometers and not more than 100 nanometers.

### Reference Example 2

In the reference example 2, the semiconductor photoelectrode comprising the semiconductor photocatalyst layer formed of a TiO₂ film was fabricated. A method for fabricating a semiconductor photoelectrode having a surface on which a plurality of pillar protrusions were arranged will be described below. The semiconductor photoelectrode thus fabricated by the method was evaluated as below.

<Method for Fabricating Semiconductor Photoelectrode>

The method for fabricating the semiconductor photoelectrode is divided roughly into the following three processes A-C.

(Process A) patterning onto a replica film

(Process B) forming a TiO₂ film on the replica film by an LPD method, and

(Process C) forming an electrode

First, in the process A, an arrangement pattern having a shape identical to the shape of a plurality of pillar protrusions is transcribed on the replica film in accordance with a nanoimprint method. Next, in the process B, a TiO₂ film is formed on the replica film by an LPD method. Finally, in the process C, a conductive substrate is formed on the TiO₂ film by non-electrolytic nickel plating. After the process C, the replica film is removed to provide an electrode formed of nickel. The processes A-C are described below in more detail.

(Process A/Patterning on the Replica Film)

In the process A, a replica film (available from Okenshoji Co., Ltd. Trade name: Bioden RFA acetyl cellulose film, thickness: 0.126 millimeters) and a silicon mold (available from KYODO INTERNATIONAL, INC.) were prepared. A plurality of nanorods were arranged on the surface of the silicon mold. This silicon mold was fabricated by a photolithography method. When viewed in a top view, one nanorod was surrounded by six nanorods, which corresponded to corners of a regular hexagon. The one nanorod was positioned at the center of the regular hexagon. Two adjacent nanorods had a pitch of 1 micrometer. Each nanorod had a diameter of 500 nanometers and a height of 1 micrometer.

Then, ethyl acetate was dropped on the replica film to soften the replica film. Subsequently, the silicon mold was pressed onto the replica film. Ethyl acetate was removed under a temperature of 70 degrees Celsius for 15 minutes by drying. After ethyl acetate was completely removed, the silicon mold was peeled from the replica film. Thus, the pattering onto the replica film was conducted.

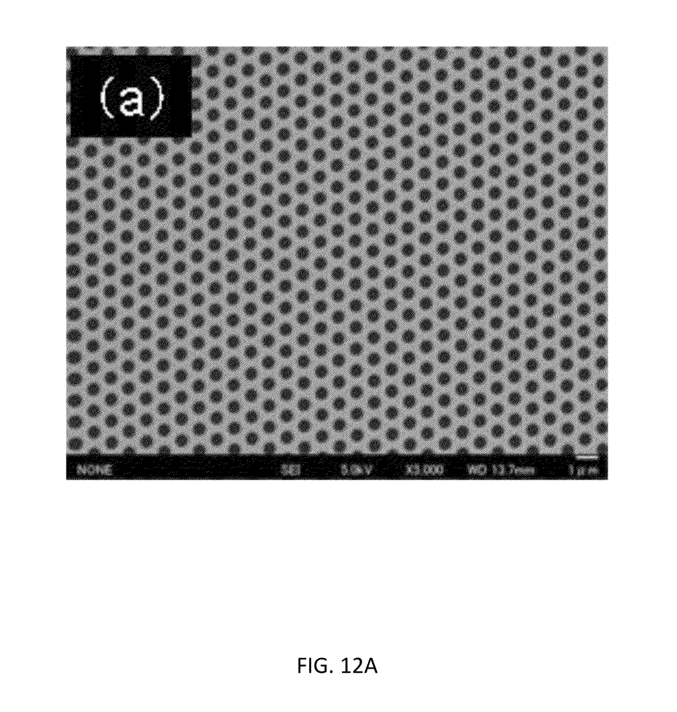

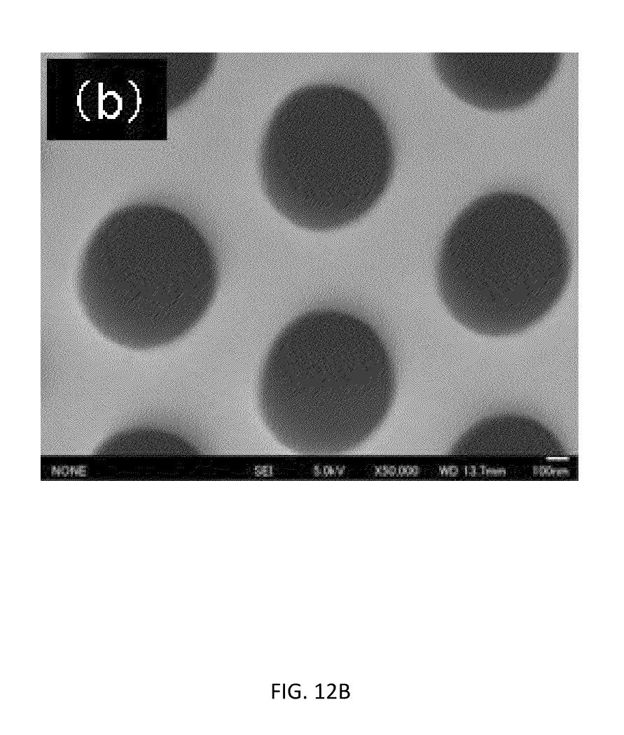

FIG. 12A shows a SEM image (5,000 magnifications) of the surface of the replica film thus patterned. FIG. 12B shows a SEM image (50,000 magnifications) of the surface of the replica film thus patterned. As is clear from FIG. 12A and FIG. 12B, a plurality of nanorods formed on the surface of the silicon mold were transcribed accurately onto the replica film. Thus, a plurality of holes were formed on the surface of the replica film.

The shape of the nanorods formed on the surface of the silicon mold may be changed so that the shape of the holes was varied. However, it is more difficult to peel the replica film from the silicon mold with an increase in the aspect ratio of the pillar protrusions. For this reason, a suitable mold-release agent may be applied on the surface of the silicon mold. For a similar reason, each nanorod may have a tapered shape.

The process A allows a patterning to be given to a lot of replica films using one silicon mold. Accordingly, the process A contributes low cost.

(Process B/Forming a TiO₂ Film on the Replica Film by an LPD Method)

First, the LPD method used in the present referential example is described. In the LPD method, used is a hydrolysis equilibrium reaction of metal fluoride complex contained in an aqueous solution. The LPD method is suitable for forming a thin film made of metal oxide on various kinds of substrates.

The following reaction formula (XI) shows the hydrolysis equilibrium reaction of metal fluoride complex contained in the aqueous solution. Boric acid is added to this reaction system. Boric acid has a high reactivity with fluorine ion, and generates more stable compound. Thus, the fluorine-consumption reaction represented by the following reaction formula (XII) progresses. For this reason, the equilibrium of the reaction formula (XI) shifts to the right. In other words, the equilibrium of the reaction formula (XI) shifts to the right so that a more amount of metal oxide precipitates. A substrate such as a replica film is immersed in the aqueous solution having a condition where both the reaction formulae (XI) and (XII) are established to form a thin film formed of metal oxide on the surface of the substrate.

MFₓ^{(x-2n)-}+nH₂O⇄MOₙ+xF⁻+2nH⁺ (XI)

H₃BO₃+4H⁺+4F⁻→HBF₄+3H₂O (XII)

where M represents metal.

The thin film made of metal oxide can be made easily and at lower cost, as compared to a vapor deposition method, a sputtering method, a chemical vapor deposition method, an electrodeposition method, and a sol-gel method, which are conventional methods for forming a thin film. Even if the substrate has a large area and the substrate has a surface where a complicated shape has been formed, the thin film made of metal oxide can be formed easily by the LPD method. As described in the referential example 2, since the thin film made of metal oxide is made uniformly by the LPD method on the replica film having a surface where a plurality of pillar protrusions have been arranged, the LPD method is significantly suitable for forming such a thin film made of metal oxide.

In the referential example 2, a LPD aqueous solution was prepared by dissolving ammonium hexafluorotitanate (available from MORITA CHEMICAL INDUSTRIES, CO., LTD.) represented by a chemical formula (NH₄)₂TiF₆ and boric acid (available from NACALAI TESQUE, INC.) represented by a chemical formula H₃BO₃ into distilled water. This LPD solution had an ammonium hexafluorotitanate concentration of 0.1M and a boric acid concentration of 0.2M. The replica film provided according to the process A was immersed in the LPD solution during a predetermined period, and a thin film made of TiO₂ was formed on the replica film. TiO₂ went into the hole formed on the surface of the replica film. In this way, formed was the TiO₂ thin film having a plurality of protrusions on the surface thereof, namely, on the front surface thereof. On the other hand, the back surface of the TiO₂ thin film had recesses each overlapped by the holes formed on the surface of the replica film. In the LPD solution, the replica film was fixed on a glass slide and disposed perpendicular to the surface of the LPD solution. A water bath was used to maintain the temperature of the LPD solution at 30 degrees Celsius.

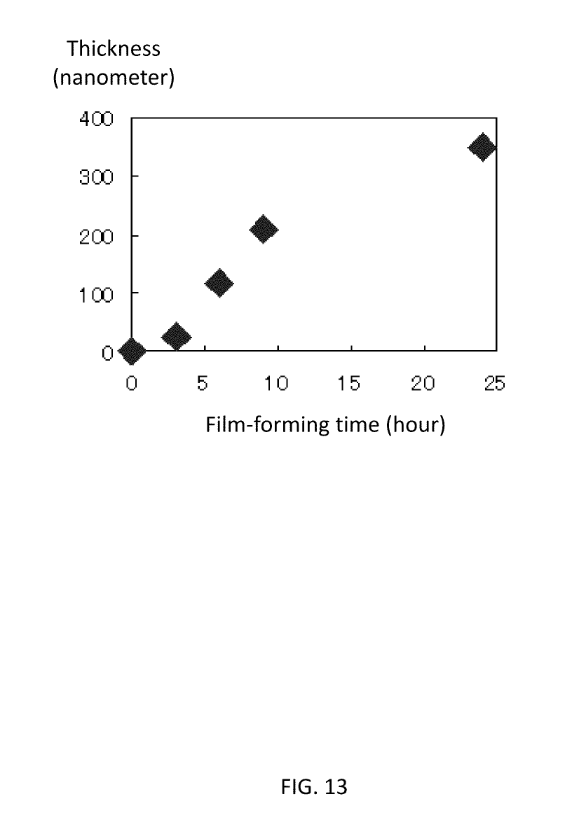

Since the thickness of the thin film made of TiO₂ is increased with an increase in film-forming time, the thickness of the thin film made of TiO₂ is variable depending on the film-forming time. In the present referential example 2, the thus-formed thin film made of TiO₂ had a thickness of 90 nanometers. FIG. 13 shows a relationship between the thickness of the thin film made of TiO₂ and the film-forming time.

(Process C)

An electrode was formed by the following procedure using the metal oxide thin film formed on the replica film.

First, a Ni film was formed under a temperature of 80 degrees Celsius for two hours by non-electrolytic nickel plating on the TiO₂ thin film formed on the replica film. In this way, a metal (Ni)-semiconductor (TiO₂) junction was formed. Since the TiO₂ thin film had a thickness of 90 nanometers, the formed Ni film played a role of holding the TiO₂ thin film. A plating solution (available from Japan Kanigen Co., Ltd., Trade name: SEK-797) was used in the non-electrolytic nickel plating. The plating solution went into the recess formed on the back surface of the TiO₂ thin film. In this way, formed was a Ni film having a plurality of protrusions made of Ni on the surface thereof, namely on the front surface thereof. The back surface of the Ni film was flat.

The obtained multilayer structure was a structure of the replica film/TiO₂/Ni. The obtained multilayer was thereafter immersed in acetone. Thus, the replica film was dissolved in acetone. In this way, the replica film was removed. A Ti metal sheet was adhered on the back surface of the Ni film. In this way, the electrode was obtained.

(Observation of the Electrode Surface)

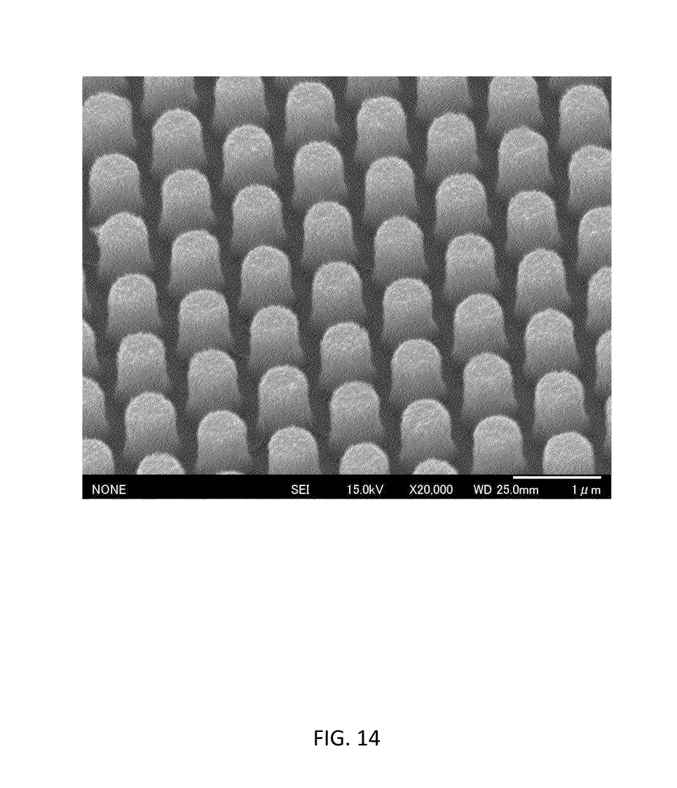

FIG. 14 shows a SEM image of the surface of the obtained electrode. A plurality of pillar protrusions similar to these of the silicon mold were arranged on the surface of the obtained electrode at a high density. It was observed from FIG. 14 that the obtained electrode had a larger area than a flat-and-smooth electrode. Hence, a semiconductor photoelectrode having a surface structure similar to the pillar protrusions of the used mold can be fabricated according to the electrode fabrication method of the referential example 2.

(Measurement of the Photocurrent)

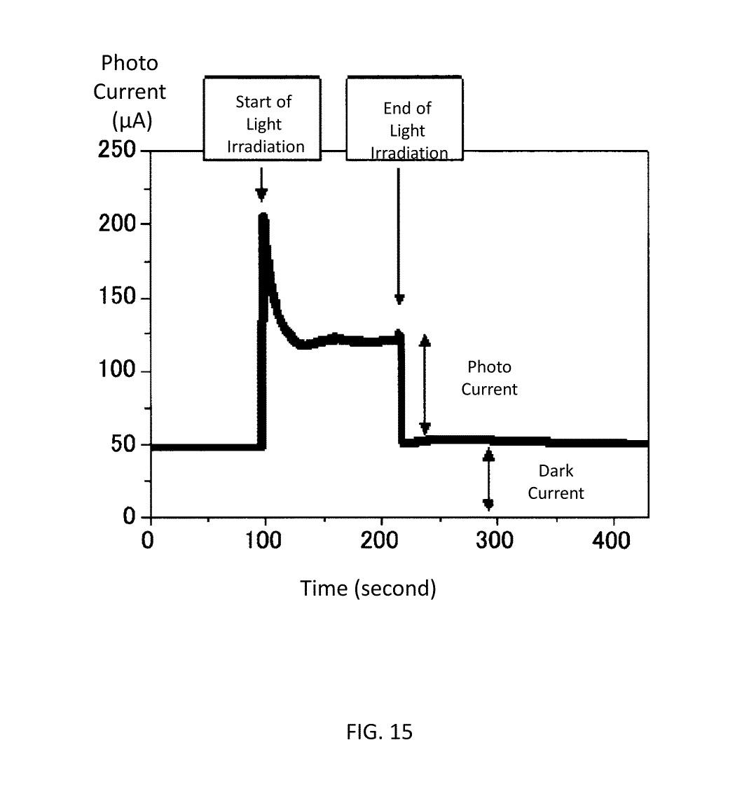

In order to confirm that the semiconductor photoelectrode fabricated according to the reference example 2 served as an electrode, a photocurrent was measured while the semiconductor photoelectrode was irradiated with ultraviolet light. The light source was a high-pressure mercury lamp having an emission line of 365 nanometers. The aqueous electrolyte solution was a 0.1M sulfuric acid aqueous solution. The counter electrode was a Pt electrode. FIG. 15 shows the result of the photocurrent measurement. As is clear from FIG. 15, when the surface of the semiconductor photoelectrode fabricated according to the referential example 2 was irradiated with the ultraviolet light, a photocurrent was measured with response to the irradiation.

### Referential Example 3

A semiconductor photoelectrode where a TiO₂ thin film was used as a semiconductor photocatalyst layer was fabricated in the referential example 3. A method for fabricating a semiconductor photoelectrode where a plurality of pillar protrusions are formed on the surface thereof will be described particularly. The evaluation results of the fabricated semiconductor photoelectrode are also described.

(Fabrication of a Conductive Substrate Having Pillar Protrusions on the Surface Thereof)

A Ti film was formed by a sputtering on the surface of a silicon mold similar to that of the referential example 2. A distance between two adjacent pillar protrusions was 2.7 micrometers. Each pillar protrusion had a diameter of 2.1 micrometers. Each pillar protrusion had a height of 21 micrometers. In the sputtering, metal titanium was used as a target. A supply rate of argon to the chamber was 3.38×10⁻³ Pa·m³/s (20 sccm). The total pressure was 1.0 Pa. The power was 150 W. In this way, the Ti film was formed on the silicon mold. A plurality of pillar protrusions were formed on the surface of the Ti film. In other words, in the reference example 3, the Ti film corresponds to a conductive substrate having a plurality of pillar protrusions on the surface thereof. A cross-sectional SEM observation revealed that the Ti film covered the silicon mold completely.

(Formation of a TiO₂ Film on the Conductive Substrate by a LPD Method)

Subsequently, a TiO₂ film was formed on the Ti film by the LPD method described in the referential example 2. The TiO₂ film had a thickness of 90 nanometers. A portion of the Ti film was not immersed in the LPD solution. The TiO₂ film was not formed on the surface of the portion of the Ti film which had not been immersed in the LPD solution. This portion where the TiO₂ film was not formed served as a current extraction portion of the semiconductor photoelectrode. Thus, an electrode composed of a stacked structure of TiO₂/Ti was obtained.

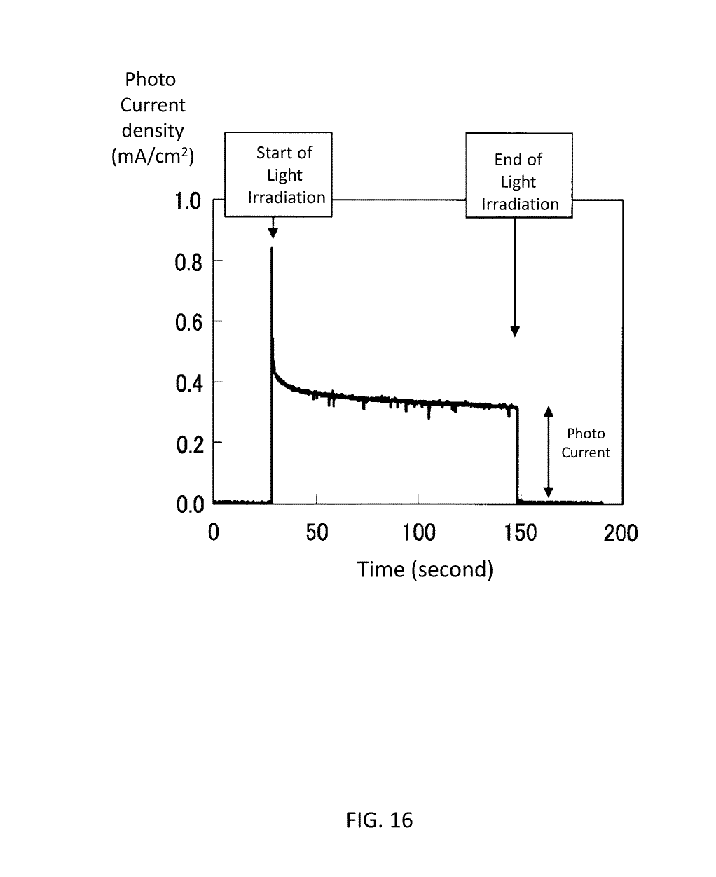

Similarly to the case of the referential example 2, the photocurrent of the semiconductor photoelectrode according to the referential example 3 was measured. FIG. 16 shows the results of the photocurrent measurement. As is clear from FIG. 16, when the surface of the semiconductor photoelectrode fabricated according to the present referential example 3 was irradiated with the ultraviolet light, a photocurrent was measured with response to the irradiation. The obtained photocurrent had a current density of approximately 0.3 milliampere/cm². No dark current was observed. This result reveals that the electrode according to the referential example 3 served as a semiconductor photoelectrode.

### Example

### Example 1

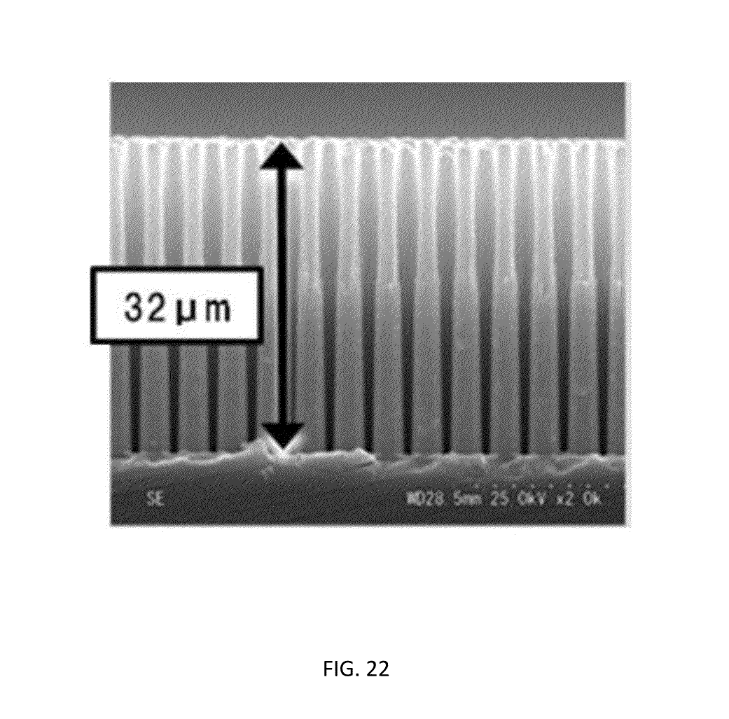

A Si pillar protrusion substrate (available from KYODO INTERNATIONAL, INC.) fabricated by a photolithography method was prepared. FIG. 21 shows a top view of this Si pillar protrusion substrate. FIG. 22 is a cross-sectional photograph of this Si pillar protrusion substrate.

One Si pillar protrusion positioned at the center was surrounded by six Si pillar protrusions, which corresponded to corners of a regular hexagon. The Si pillar protrusion substrate had a plurality of Si pillar protrusions. Each Si pillar protrusion was circular cylindrical. The top of each Si pillar protrusion was tapered. In other words, the top of each Si pillar protrusion was sharpened. The bottom of each Si pillar protrusion had a diameter of 2 micrometers. A pitch h between the centers of two adjacent Si pillar protrusions was 4 micrometers. Each Si pillar protrusion had a height of 32 micrometers. The aspect ratio (=height/diameter) of each Si pillar protrusion was approximately 16.

A conductive film made of titanium was formed by a sputtering method on the surface of the Si pillar protrusion substrate. In the sputtering method, a metal Ti was used as a target. The total pressure was 0.1 Pa. The power was 1 kW. In this way, a Ti film was formed on the Si pillar protrusion substrate. It was observed by a cross-sectional SEM observation and Auger measurement method that the Ti film was formed not only on the top and middle of the Si pillar protrusions but also on the bottom of the Si pillar protrusions.

The Ti film was formed in such a manner that the Ti film had a thickness of 400 nanometers in a case where the Ti film was formed on a flat-and-smooth Si wafer surface under a similar sputtering condition.

(Formation of a TiO₂ Film on the Conductive Substrate by the LPD Method)

Subsequently, a TiO₂ film was formed on the Ti film by the LPD method, which has been described above. The LPD condition was similar to the condition where a TiO₂ film having a thickness of 90 nanometers was formed by the LPD method on the surface of the flat-and-smooth Ti film. In the LPD method, a film having a uniform thickness along the surface shape can be formed. In this way, a TiO₂ film having a thickness of 90 nanometers was formed on the Ti film.

A part of the Ti film was not immersed in the LPD solution. The TiO₂ film was not formed on the surface of the part of the Ti film which had not been immersed in the LPD solution. The part where the TiO₂ film was not formed functioned as an electric current extraction part of the semiconductor photoelectrode. In this way, an electrode comprised of a stacked structure of TiO₂/Ti was obtained.

The formed TiO₂ film contained a lot of water. Furthermore, the TiO₂ film contained titanium hydroxide. The TiO₂ film was subjected to heat treatment in the air for two hours under a temperature of 450 degrees Celsius to improve the crystallinity of the TiO₂ film. In this way, the TiO₂ film was crystallized.

(Formation of a NbON Film on the TiO₂ Film by a Sputtering & Ammonia Nitriding Method)

A Nb₂O₅ film was formed as a precursor of a NbON film on the surface of the TiO₂ film by a sputtering method. In the sputtering method, Nb₂O₅ was used as a target. The total pressure was 1.0 Pa. The power was 150 W. The Nb₂O₅ film was formed in such a manner that the Nb₂O₅ film having a thickness of 100 nanometers was formed in a case where the Nb₂O₅ film was formed on the flat-and-smooth quartz substrate under a similar condition. In this way, a stacked structure of Nb₂O₅/TiO₂/Ti/Si pillar protrusions was fabricated.

In order to turn the Nb₂O₅ film formed at the uppermost surface into the NbON film, the fabricated stacked structure was subjected to sintering under gas current containing ammonia to nitride the Nb₂O₅ film. Specifically, the stacked structure was put into a furnace. While gaseous mixture containing 20 volume % of ammonia, 0.12 volume % of oxygen, and 79.88 volume % of nitrogen flows through the furnace, the temperature of the inside of the furnace was raised from room temperature to 750 degrees Celsius at a temperature rising rate of 100 degrees Celsius/hour. Then, the Nb₂O₅ film was maintained at a temperature of 750 degrees Celsius. Finally, the temperature of the inside of the furnace was lowered at a temperature cooling rate of 100 degrees Celsius/hour. Thus, a stacked structure of NbON/TiO₂/Ti/Si pillar protrusions was fabricated.

Since a surface oxide film was formed on the part of the Ti film which had not been immersed in the LPD solution, the part of the Ti film was polished so that the surface oxide film was removed. In this way, the part of the Ti film was exposed. A copper wire was electrically connected to the exposed Ti film with a silver paste. The copper wire was fixed with an epoxy resin. In this way, a semiconductor photoelectrode having a stacked structure of NbON/TiO₂/Ti/Si pillar protrusions was obtained.

(Measurement of the Photocurrent)

In order to evaluate the photocurrent property of the obtained semiconductor photoelectrode, while the semiconductor photoelectrode was irradiated with visible light having a wavelength of 436 nanometers, the photocurrent was measured. The light source was a high-pressure mercury lamp having an emission line of 436 nanometers. The energy of the incident light was 37.6 mW/cm². The aqueous electrolyte solution was a 0.1M sulfuric acid aqueous solution. The counter electrode was a Pt electrode.

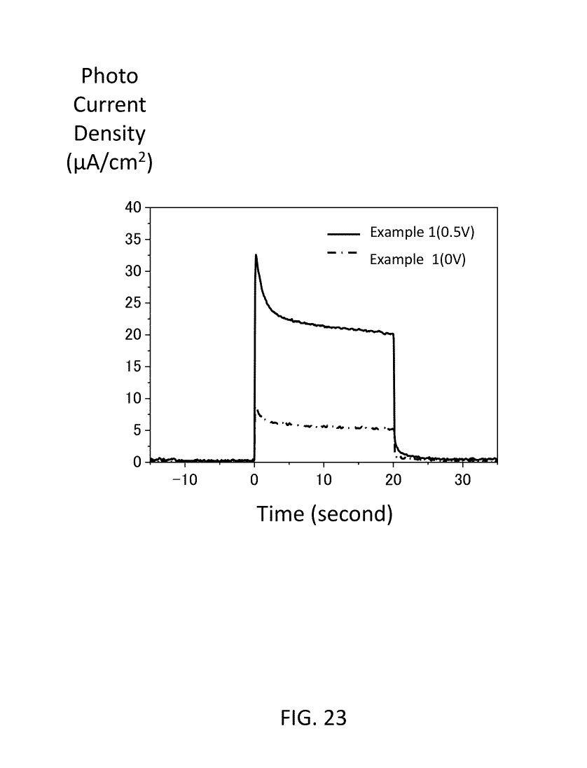

First, a photocurrent was measured without applying an external bias to the semiconductor photoelectrode. Then, the photocurrent was measured, while an external bias of 0.5 volts was applied to the semiconductor photoelectrode. FIG. 23 shows these results.

As is clear from FIG. 23, when the surface of the obtained semiconductor photoelectrode was irradiated with the visible light, the photocurrent was measured so as to response to the irradiation. Furthermore, the value of the photocurrent was increased by the external bias. The maximum value of the photocurrent was approximately 32 microampere/cm².

It was believed that the reason why the external bias increased the photocurrent was that the charge separation of the photo-excited carrier was promoted and that the external bias was used as a part of the energy required for water splitting reaction.

### Comparative Example 1

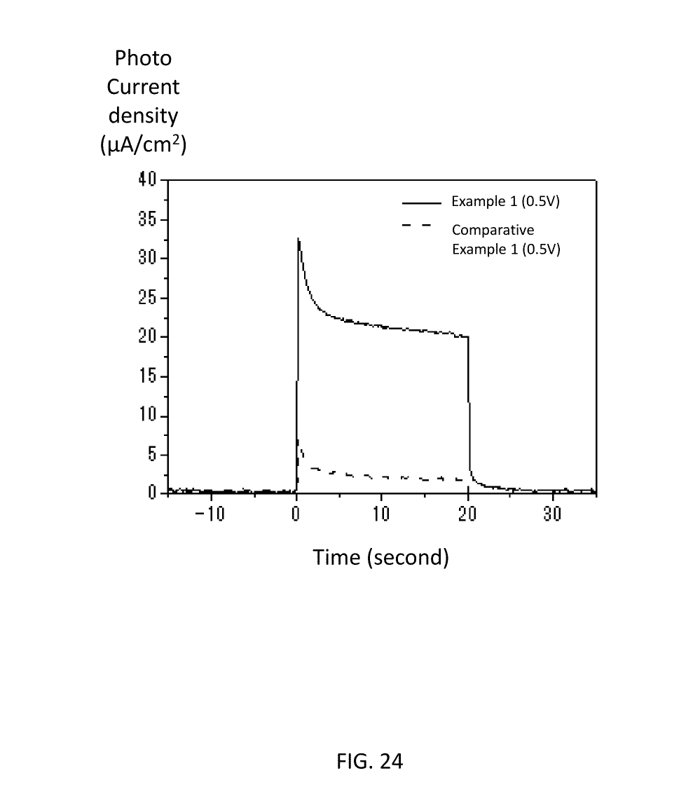

A semiconductor photoelectrode was fabricated in the same manner as in the example 1, expect that a Si wafer which did not have a plurality of pillar protrusions was used as a substrate. Using this semiconductor photoelectrode according to the comparative example 1, the photocurrent was measured, while the external bias of 0.5 volts was applied. The maximum value of the photocurrent in the comparative example 1 was approximately 7 microampere/cm². FIG. 24 shows the results of the photocurrent in the case of using the semiconductor photoelectrodes according to the example 1 and the comparative example 1.

As is clear from FIG. 24, as compared to the case where the semiconductor photoelectrode according to the comparative example 1, a higher photocurrent was obtained in the case of the semiconductor photoelectrode according to the example 1. The present inventors observed that a higher photocurrent was obtained in the case of using the semiconductor photoelectrode according to the example 1, as compared to the case of using the semiconductor photoelectrode according to the comparative example 1, even when the external bias was not applied.

### INDUSTRIAL APPLICABILITY

The semiconductor photoelectrode according to the present invention has a larger surface area, since the semiconductor photoelectrode has a surface where a plurality of pillar protrusions are arranged. For this reason, improved is the quantum efficiency of hydrogen-generating reaction generated by irradiating with light. The semiconductor photoelectrode according to the present invention can be used for an energy system such as a hydrogen-generating device using water splitting, and is thus industrially useful.

### REFERENTIAL SIGNS LIST

200 semiconductor photoelectrode
102 conductive substrate
EFC Fermi level of the conductive substrate
201 semiconductor photocatalyst layer
202 first semiconductor layer
EFN1 Fermi level of the first semiconductor layer
EV1 top of the valence band of the first semiconductor layer
EC1 bottom of the conduction band of the first semiconductor layer
203 second semiconductor layer
EFN2 Fermi level of the second semiconductor layer
EV2 top of the valence band of the second semiconductor layer
EC2 bottom of the conduction band of the second semiconductor layer
300 photoelectrochemical cell
31 container
31a light-entrance portion
32 counter electrode
33 aqueous electrolyte solution or water
34 electric wire
35 separator
36 first chamber
37 second chamber
38 first outlet
39 second outlet
40 inlet
400 light

1. A semiconductor photoelectrode, comprising:
a conductive substrate;
a first semiconductor photocatalyst layer provided on a surface of the conductive substrate;
a second semiconductor photocatalyst layer provided on a surface of the first semiconductor photocatalyst layer,
wherein
an energy difference between Fermi level of the conductive substrate and vacuum level is smaller than an energy difference between Fermi level of the first semiconductor photocatalyst layer and the vacuum level;
an energy difference between Fermi level of the first semiconductor photocatalyst layer and the vacuum level is smaller than an energy difference between Fermi level of the second semiconductor photocatalyst layer and the vacuum level;
an energy difference between a top of a valence band of the first semiconductor photocatalyst layer and the vacuum level is greater than an energy difference between a top of a valence band of the second semiconductor photocatalyst layer and the vacuum level;
an energy difference between a bottom of a conduction band of the first semiconductor photocatalyst layer and the vacuum level is greater than an energy difference between a bottom of a conduction band of the second semiconductor photocatalyst layer and the vacuum level;
the semiconductor photoelectrode has a plurality of pillar protrusions on the surface thereof; and
a surface of each of the pillar protrusions is formed of the second semiconductor photocatalyst layer.

2. The semiconductor photoelectrode according to claim 1, wherein
a part of the first semiconductor photocatalyst layer and a part of the conductive substrate are included in an inside of each of the pillar protrusions;
the part of the conductive substrate included in the inside of each of the pillar protrusions has a shape of a pillar;
the part of the conductive substrate included in the inside of each of the pillar protrusions is covered with the first semiconductor photocatalyst layer included in the inside of each pillar protrusion; and
the part of the first semiconductor photocatalyst layer included in the inside of each of the pillar protrusions is covered with the second semiconductor photocatalyst layer formed on the surface of each pillar protrusion.

3. The semiconductor photoelectrode according to claim 2, wherein
the first semiconductor photocatalyst layer has a thickness of not less than 10 nanometers and not more than 100 nanometers.

4. The semiconductor photoelectrode according to claim 1, wherein
the first semiconductor photocatalyst layer is formed of at least one compound selected from the group consisting of oxide, nitride, and oxynitride; and
the at least one compound contains at least one element selected from the group consisting of Ti, Nb, and Ta.

5. The semiconductor photoelectrode according to claim 1, wherein
the second semiconductor photocatalyst layer is formed of at least one compound selected from the group consisting of oxide, nitride, and oxynitride; and
the at least one compound contains at least one element selected from the group consisting of Ti, Nb, and Ta.

6. The semiconductor photoelectrode according to claim 1, wherein
the conductive substrate is composed of a plurality of metal layers.

7. The semiconductor photoelectrode according to claim 1, wherein
a top end of each of the pillar protrusions sharpens.

8. A method for splitting water photoelectrochemically, the method comprising:
(a) preparing a photoelectrochemical cell comprising:
the semiconductor photoelectrode according to claim 1;
a counter electrode electrically connected to the electric conductor;
a liquid which is in contact with a surface of the semiconductor photoelectrode and a surface of the counter electrode; and
a container for holding the semiconductor photoelectrode, the counter electrode, and the liquid,
wherein
the liquid is an aqueous electrolyte solution or water, and
(b) irradiating the semiconductor photoelectrode with light thereby splitting the aqueous electrolyte solution or water.

9. The method according to claim 8, wherein
the semiconductor photoelectrode is irradiated with the light from a direction which is inclined with respect to the pillar protrusion in the step (b).

10. The method according to claim 8, wherein
a part of the first semiconductor photocatalyst layer and a part of the conductive substrate are included in an inside of each of the pillar protrusions;
the part of the conductive substrate included in the inside of each of the pillar protrusions has a shape of a pillar;
the part of the conductive substrate included in the inside of each of the pillar protrusions is covered with the first semiconductor photocatalyst layer included in the inside of each of the pillar protrusions; and
the part of the first semiconductor photocatalyst layer included in the inside of each of the pillar protrusions is covered with the second semiconductor photocatalyst layer formed on the surface of each of the pillar protrusions.

11. The method according to claim 10, wherein
the first semiconductor photocatalyst layer has a thickness of not less than 10 nanometers and not more than 100 nanometers.

12. The method according to claim 8, wherein
the first semiconductor photocatalyst layer is formed of at least one compound selected from the group consisting of oxide, nitride, and oxynitride; and
the at least one compound contains at least one element selected from the group consisting of Ti, Nb, and Ta.

13. The method according to claim 8, wherein
the second semiconductor photocatalyst layer is formed of at least one compound selected from the group consisting of oxide, nitride, and oxynitride; and
the at least one compound contains at least one element selected from the group consisting of Ti, Nb, and Ta.

14. The method according to claim 8, wherein
the conductive substrate is composed of a plurality of metal layers.

15. The method according to claim 8, wherein
a top end of each of the pillar protrusions sharpens.

16. A photoelectrochemical cell for splitting water photoelectrochemically, comprising:
the semiconductor photoelectrode according to claim 1;
a counter electrode electrically connected to the electric conductor; and
a container for holding the semiconductor photoelectrode and the counter electrode.

17. The photoelectrochemical cell according to claim 16, wherein
a part of the first semiconductor photocatalyst layer and a part of the conductive substrate are included in an inside of each of the pillar protrusions;
the part of the conductive substrate included in the inside of each of the pillar protrusions has a shape of a pillar;
the part of the conductive substrate included in the inside of each of the pillar protrusions is covered with the first semiconductor photocatalyst layer included in the inside of each of the pillar protrusions; and
the part of the first semiconductor photocatalyst layer included in the inside of each of the pillar protrusions is covered with the second semiconductor photocatalyst layer formed on the surface of each of the pillar protrusions.

18. The photoelectrochemical cell according to claim 17, wherein
the first semiconductor photocatalyst layer has a thickness of not less than 10 nanometers and not more than 100 nanometers.

19. The photoelectrochemical cell according to claim 16, wherein
the first semiconductor photocatalyst layer is formed of at least one compound selected from the group consisting of oxide, nitride, and oxynitride; and
the at least one compound contains at least one element selected from the group consisting of Ti, Nb, and Ta.

20. The photoelectrochemical cell according to claim 16, wherein
the second semiconductor photocatalyst layer is formed of at least one compound selected from the group consisting of oxide, nitride, and oxynitride; and
the at least one compound contains at least one element selected from the group consisting of Ti, Nb, and Ta.

21. The photoelectrochemical cell according to claim 16, wherein
the conductive substrate is composed of a plurality of metal layers.

22. The photoelectrochemical cell according to claim 16, wherein
a top end of each of the pillar protrusions sharpens.

23. A method for generating hydrogen, the method comprising:
(a) preparing a photoelectrochemical cell comprising:
the semiconductor photoelectrode according to claim 1;
a counter electrode electrically connected to the electric conductor;
a liquid which is in contact with a surface of the semiconductor photoelectrode and a surface of the counter electrode; and
a container for holding the semiconductor photoelectrode, the counter electrode, and the liquid; wherein
the liquid is an aqueous electrolyte solution or water; and
(b) irradiating the semiconductor photoelectrode with light to generate hydrogen on the surface of the semiconductor photoelectrode.

24. The method according to claim 23, wherein
the semiconductor photoelectrode is irradiated with the light which is incident in a direction which is inclined with respect to the pillar protrusion in the step (b).
